(19) United States
(12) Patent Application Publication
(10) Pub. No.: US 2020/0218696 A1
(43) Pub. Date: Jul. 9, 2020

(54) SEARCH INTERFACE FOR A CONSOLIDATED VEHICLE INFORMATION SYSTEM

(71) Applicant: SF Motors, Inc., Santa Clara, CA (US)

(72) Inventors: Jaime Camhi, Santa Clara, CA (US); Avery Jutkowitz, Santa Clara, CA (US); Hakuei Huang, Santa Clara, CA (US); Nischitha Mallikarjuna, Santa Clara, CA (US); Ajay Bandi, Santa Clara, CA (US); Joshua Hoffman, Santa Clara, CA (US); Xiaoran Yao, Santa Clara, CA (US)

(21) Appl. No.: 16/243,348

(22) Filed: Jan. 9, 2019

(51) Int. Cl. G06F 16/14; G06F 9/451; G06F 16/2457; G06N 5/04; G06F 3/0482

(52) U.S. Cl. CPC G06F 16/156; G06F 16/148; G06F 3/0482; G06F 16/24578; G06N 5/048; G06F 9/451

(57) ABSTRACT

Provided herein is a consolidated vehicle information cluster. The information cluster can include a vehicle based data processing system in a vehicle having a search module and a prediction module. The information cluster can include a search interface provided within a first display of a display module. The search interface can obtain a first input and can identify a first data file and a second data file. The prediction module can generate, from the first data file, a first data structure and, from the second data file, a second data structure. The vehicle based data processing system can provide a first output corresponding to the first data structure and a second output corresponding to the second data structure for concurrent display by the search interface. The search interface can receive a user selection of the second output corresponding to the second data structure.

### BACKGROUND

Vehicles can include different information systems to provide information related to the vehicle.

### SUMMARY

At least one aspect is directed to a consolidated vehicle information cluster (e.g., an information cluster). The information cluster can include a vehicle based data processing system in a vehicle having a search module and a prediction module. The information cluster can include a search interface communicatively coupled with the vehicle based data processing system. The search interface can be provided within a first display of a display module of the vehicle. The search interface can obtain a first input from a user of the vehicle. The search module can receive the first input from the search interface. The search module can identify, responsive to the first input, a first data file and a second data file. The first data file and the second data file can be identified from at least one of a phone menu, a navigation menu, an entertainment menu, a climate control menu and an application. The prediction module can generate, from the first data file, a first data structure. The first data structure can correspond to a first action to be executed using at least one of the phone menu, the navigation menu, the entertainment menu, the climate control menu and the application. The prediction module can generate, from the second data file, a second data structure. The second data structure can correspond to a second action to be executed using at least one of the phone menu, the navigation menu, the entertainment menu, the climate control menu and the application. The vehicle based data processing system can generate a first output corresponding to the first data structure and a second output corresponding to the second data structure. The vehicle based data processing system can provide the first output and the second output for concurrent display by the search interface. The search interface can receive a user selection of the second output corresponding to the second data structure. The vehicle based data processing system can provide instructions to invoke second action corresponding to the second data structure. The vehicle based data processing system can execute the second action for the vehicle using at least one of the phone menu, the navigation menu, the entertainment menu, the climate control menu and the application.

At least one aspect is directed to a method of providing data structures to a search interface for a vehicle information cluster. The method can include providing, by a vehicle based data processing system in a vehicle, a search interface. The search interface can be provided within a first display of a display module of the vehicle. The vehicle based data processing system can have a search module and a prediction module. The method can include obtaining, from the search interface, a first input from a user of the vehicle. The method can include receiving, by the search module, the first input from the search interface. The method can include identifying, by the search module and responsive to the first input, a first data file and a second data file. The first data file and the second data file can be identified from at least one of a phone menu, a navigation menu, an entertainment menu, a climate control menu and an application. The method can include generating, by the prediction module and from the first data file, a first data structure. The first data structure can correspond to a first action to be executed using at least one of the phone menu, the navigation menu, the entertainment menu, the climate control menu and the application. The method can include generating, by the prediction module and from the second data file, a second data structure. The second data structure can correspond to a second action to be executed using at least one of the phone menu, the navigation menu, the entertainment menu, the climate control menu and the application. The method can include generating, by the vehicle based data processing system, a first output corresponding to the first data structure and a second output corresponding to the second data structure. The method can include providing, by the vehicle based data processing system, the first output and the second output for concurrent display by the search interface. The method can include receiving, by the search interface, a user selection of the second output corresponding to the second data structure. The method can include providing, by the vehicle based data processing system, instructions to invoke second action corresponding to the second data structure. The vehicle based data processing system can execute the second action for the vehicle using at least one of the phone menu, the navigation menu, the entertainment menu, the climate control menu and the application.

At least one aspect is directed to a method. The method can provide a consolidated vehicle information cluster (e.g., an information cluster). The information cluster can include a vehicle based data processing system in a vehicle having a search module and a prediction module. The information cluster can include a search interface communicatively coupled with the vehicle based data processing system. The search interface can be provided within a first display of a display module of the vehicle. The search interface can obtain a first input from a user of the vehicle. The search module can receive the first input from the search interface. The search module can identify, responsive to the first input, a first data file and a second data file. The first data file and the second data file can be identified from at least one of a phone menu, a navigation menu, an entertainment menu, a climate control menu and an application. The prediction module can generate, from the first data file, a first data structure. The first data structure can correspond to a first action to be executed using at least one of the phone menu, the navigation menu, the entertainment menu, the climate control menu and the application. The prediction module can generate, from the second data file, a second data structure. The second data structure can correspond to a second action to be executed using at least one of the phone menu, the navigation menu, the entertainment menu, the climate control menu and the application. The vehicle based data processing system can generate a first output corresponding to the first data structure and a second output corresponding to the second data structure. The vehicle based data processing system can provide the first output and the second output for concurrent display by the search interface. The search interface can receive a user selection of the second output corresponding to the second data structure. The vehicle based data processing system can provide instructions to invoke second action corresponding to the second data structure. The vehicle based data processing system can execute the second action for the vehicle using at least one of the phone menu, the navigation menu, the entertainment menu, the climate control menu and the application.

At least one aspect is directed to a vehicle such as an electric vehicle. The electric vehicle can include a consolidated vehicle information cluster (e.g., an information cluster). The information cluster can include a vehicle based data processing system in a vehicle having a search module and a prediction module. The information cluster can include a search interface communicatively coupled with the vehicle based data processing system. The search interface can be provided within a first display of a display module of the vehicle. The search interface can obtain a first input from a user of the vehicle. The search module can receive the first input from the search interface. The search module can identify, responsive to the first input, a first data file and a second data file. The first data file and the second data file can be identified from at least one of a phone menu, a navigation menu, an entertainment menu, a climate control menu and an application. The prediction module can generate, from the first data file, a first data structure. The first data structure can correspond to a first action to be executed using at least one of the phone menu, the navigation menu, the entertainment menu, the climate control menu and the application. The prediction module can generate, from the second data file, a second data structure. The second data structure can correspond to a second action to be executed using at least one of the phone menu, the navigation menu, the entertainment menu, the climate control menu and the application. The vehicle based data processing system can generate a first output corresponding to the first data structure and a second output corresponding to the second data structure. The vehicle based data processing system can provide the first output and the second output for concurrent display by the search interface. The search interface can receive a user selection of the second output corresponding to the second data structure. The vehicle based data processing system can provide instructions to invoke second action corresponding to the second data structure. The vehicle based data processing system can execute the second action for the vehicle using at least one of the phone menu, the navigation menu, the entertainment menu, the climate control menu and the application.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing. In the drawings:

FIG. 1 is a block diagram depicting a consolidated vehicle information cluster within a vehicle, according to an illustrative implementation;

FIG. 2 is a block diagram depicting a consolidated vehicle information cluster having a search interface and disposed within a console of a vehicle, according to an illustrative implementation;

FIG. 3 is a block diagram depicting a first layout of a consolidated vehicle information cluster, according to an illustrative implementation;

FIG. 4 is a block diagram depicting a second layout of a consolidated vehicle information cluster, according to an illustrative implementation;

FIG. 5 is a flow diagram depicting an example method of providing data structures to a search interface for a vehicle information cluster;

FIG. 6 is a flow diagram depicting an example method of providing data structures to a search interface for a vehicle information cluster; and

FIG. 7 is a block diagram illustrating an architecture for a computer system that can be employed to implement elements of the systems and methods described and illustrated herein, including, for example, the system depicted in FIGS. 1-4, and the methods depicted in FIGS. 5-6.

### DETAILED DESCRIPTION

Following below are more detailed descriptions of various concepts related to, and implementations of a consolidated vehicle navigation and information system for a vehicle, such as electric vehicles. The various concepts introduced above and discussed in greater detail below can be implemented in any of numerous ways.

Systems and methods described herein relate to a consolidated vehicle information interface (also referred to herein as “information cluster”) for a vehicle. The information cluster can provide search functionality to a user of a vehicle to search for different applications or systems of the vehicle from a single consolidated interface. For example, the information cluster can include a vehicle based data processing system to extract and receive data from multiple applications or systems of the vehicle to provide the data to the user of the vehicle in the single consolidated interface. The vehicle based data processing system can couple with a display module providing a search interface. The search interface can receive inputs from a user of the vehicle and provide the inputs to the vehicle based data processing system. The vehicle based data processing system can include a search module to identify applications, actions or systems of the vehicle corresponding to the input. The vehicle based data processing system can include a prediction module to generate predictions (e.g., links, actions) corresponding to the applications and system of the vehicle and based on the input received by the user of the vehicle.

The display module of the information cluster can dedicate at least one display to the search interface such that the search interface is visible to a user of the vehicle when the vehicle is active, on or otherwise in use. The user of the vehicle can interact with the search interface to find or identify different applications or systems (e.g., navigation menu, phone menu, entertainment menu) from a single interface and be provided prediction content or actions corresponding to the different applications or systems. Thus, instead of interacting with each application or system individually, the information cluster can combine processing power of multiple systems into a single system having a single display to efficiently manage the allocation of computer resources within the vehicle.

The vehicle based data processing system can generate the search interface to receive search query from a user of the vehicle through the information cluster. Responsive to the search query, the vehicle based data processing system can execute the search module to identify applications or systems of the vehicle corresponding to the search query. The vehicle based data processing system can execute the prediction module to generate predicted actions or predicted results corresponding to the identified applications or systems of the vehicle and based on the search query. For example, the search interface can receive an input corresponding to a name of a person. The vehicle based data processing system can execute to the search module to identify a phone menu including the name of the person and a navigation menu including the name of the person. The vehicle based data processing system can execute the prediction module to generate a phone number to call (e.g., action) a person corresponding to the entered name. The vehicle based data processing system can execute the prediction module to generate a geographical location through the navigation menu and directions to drive to the geographical location corresponding to the entered name. The vehicle based data processing system can aggregate data and information from multiple systems (e.g., phone menu, navigation menu, climate control menu) through the single consolidated information cluster.

The consolidated information cluster can allow a user of the vehicle to interact with the navigation application and different systems or applications of the vehicle from a single consolidated system. The consolidated interface can consolidate or combine different processors and logic from multiple systems or components of a vehicle into a single system to more efficiently manage computer resources of the respective vehicle. The consolidated information cluster can couple with a single display module having multiple displays to consolidate hardware resources of the respective vehicle. For example, instead of multiple different displays, each of which provide content corresponding to different systems of the vehicle, the consolidated interfaces as described herein can provide a single system with a single display module to provide content from each of the different systems of the vehicle and the navigation application. Thus, separate displays, panels, processors, or logic can be eliminated or reduced to more efficiently manage the computer resources (e.g., software, hardware) of the respective vehicle. This can reduce vehicle weight and increase vehicle range per charge or fuel cycle. The consolidated information cluster can improve computer resource allocation by eliminating or reducing the amount of separate and distinct processors and hardware elements for vehicle systems that may be used sparingly. Thus, conserving and efficiently allocating computer resources of the respective vehicle through the consolidated information cluster. The consolidated information cluster can include a touch screen display to provide an input device via the display module in a common location such that the user of the vehicle can interact with the different systems and applications of the vehicle from a single vantage point. This can help to conserve computer resources, and may avoid or eliminate different systems of the vehicle each having independent input devices for a user of the vehicle to interact with the respective system of the vehicle.

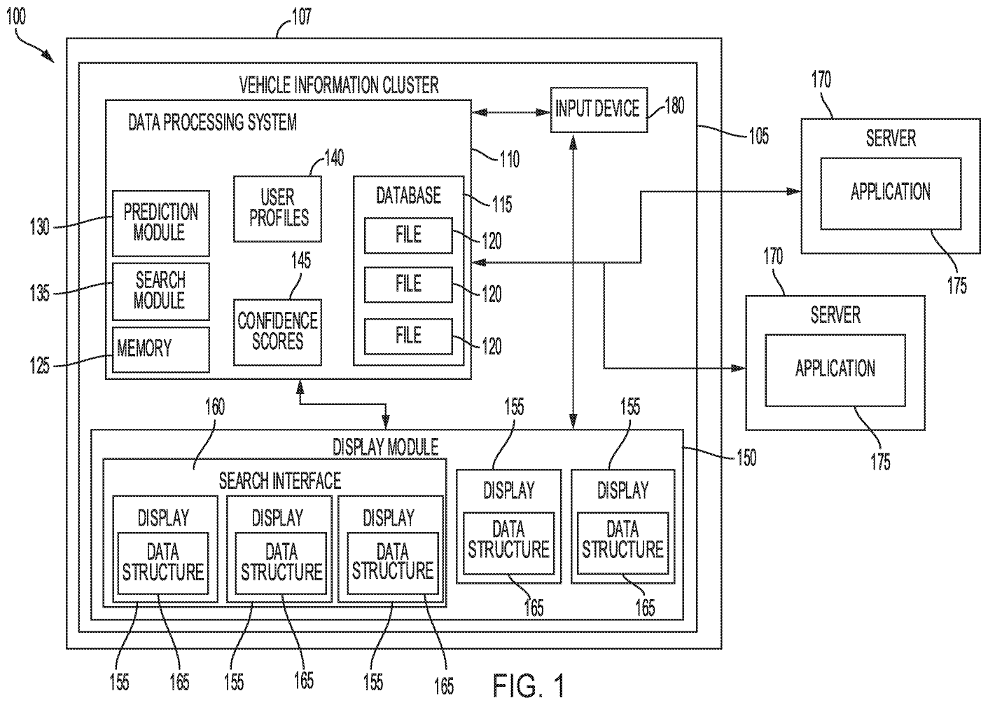

FIG. 1, among others, depicts a view 100 of a block diagram of a consolidated vehicle information cluster 105 (“information cluster”) for a vehicle 107. The vehicle 107 can include a configuration, arrangement or network of electrical, electronic, mechanical or electromechanical devices within a vehicle of any type. The vehicle 107 can include automobiles, cars, trucks, passenger vehicles, industrial vehicles, motorcycles, and other transport vehicles. The vehicle 107 can include electric vehicles, electric automobiles, cars, motorcycles, scooters, passenger vehicles, passenger or commercial trucks, and other vehicles such as sea or air transport vehicles, planes, helicopters, submarines, boats, or drones. The vehicle 107 can be fully autonomous, partially autonomous, or unmanned. Thus, the vehicle 107 can include an autonomous, semi-autonomous, or non-autonomous human operated vehicle. The vehicle 107 can include a hybrid vehicle that operates from on-board electric sources and from gasoline or other power sources. The vehicle 107 can include an electric vehicle (EVs), hybrid vehicle, fossil fuel vehicle, a car, a truck, motorcycles, scooters, passenger vehicles, passenger or commercial trucks, and other vehicles such as sea or air transport vehicles, planes, helicopters, submarines, boats, or drones. The EV s can include electric automobiles, cars, motorcycles, scooters, passenger vehicles, passenger or commercial trucks, and other vehicles such as sea or air transport vehicles, planes, helicopters, submarines, boats, or drones. EVs can be fully autonomous, partially autonomous, or unmanned.

The information cluster 105 can couple multiple different systems, including a search interface 160, or other applications executing within, executing on the vehicle 107 or external to the vehicle 107 (e.g., at least one third party server, servers 170) within a single system to conserve and more efficiently allocate computer resources of the respective vehicle 107 through the information cluster 105. The information cluster 105 can include a vehicle based data processing system (e.g., DPS) 110. The vehicle based data processing system 110 can generate content for display through the different displays 155 of the display module 150. The vehicle based data processing system 110 can generate data structures 165 corresponding to actions for different applications or systems of the vehicle 107. For example, the vehicle based data processing system 110 can receive an input from a user of the vehicle 107 through a search interface 160 and generate data structures 165 corresponding the input from the user.

The vehicle based data processing system 110 can include a database 115 and a memory 125. The vehicle based data processing system 110 can be implemented using hardware or a combination of software and hardware. For example, each component of the vehicle based data processing system 110 can include logical circuity (e.g., a central processing unit or CPU) that responses to and processes instructions fetched from a memory unit (e.g., memory 125). Each component of the vehicle based data processing system 110 can include or use a microprocessor or a multi-core processor. A multi-core processor can include two or more processing units on a single computing component. Each component of the vehicle based data processing system 110 can be based on any of these processors, or any other processor capable of operating as described herein. Each processor can utilize instruction level parallelism, thread level parallelism, different levels of cache, etc. For example, the vehicle based data processing system 110 can include at least one logic device such as a computing device or server having at least one processor to communicate via a network with one or more systems of the vehicle 107. The components and elements (e.g., database 115, memory 125) of the vehicle based data processing system 110 can be separate components, a single component, or part of the vehicle based data processing system 110. For example, the database 115 and the memory 125) can include combinations of hardware and software, such as one or more processors configured to initiate stop commands, initiate motion commands, and transmit or receive timing data, for example.

The database 115 can include a structured set of data stored for the vehicle based data processing system 110. For example, the database 115 can include a plurality of data files 120 corresponding to identified applications or systems. The data files 120 can be generated by a search module 135 of the vehicle based data processing system 110 responsive to an input via the search interface 160 by a user of the vehicle. The database 115 can include a plurality of data structures 165 corresponding to predicted actions generated by a prediction module 130 of the vehicle based data processing system 110. The database 115 can include a plurality of outputs corresponding to the plurality of data structures 165. The database 115 can include a plurality of actions corresponding to the plurality of data structures 165. The data structures can include predicted actions (e.g., call first contact, drive to first location) generated in response to an input via the search interface 160 by a user of the vehicle. The database 115 can couple with the memory 125 to store and retrieve data, such as, user inputs, data files 120, data structures 165, requests, user profiles 140, confidence scores 145, contact inputs, touch inputs, audio inputs, geographical information, vehicle information, command instructions, vehicle status information, environmental information within or external to the vehicle, road status or road condition information, vehicle location information or other information during execution of instructions by the vehicle based data processing system 110. The memory 125 can include a random access memory (RAM) or other dynamic storage device, coupled with the vehicle based data processing system 110 for storing information, and instructions to be executed by the vehicle based data processing system 110. The memory 125 can be used for storing user inputs, files 120, data structures 165, requests, user profiles 140, confidence scores 145, contact inputs, touch inputs, audio inputs, geographical information, vehicle information, command instructions, vehicle status information, environmental information within or external to the vehicle, road status or road condition information, vehicle location information or other information during execution of instructions by the vehicle based data processing system 110. The memory 125 can include at least one read only memory (ROM) or other static storage device coupled with the vehicle based data processing system 110 for storing static information and instructions for the vehicle based data processing system 110. The memory 125 can include a storage device, such as a solid state device, magnetic disk or optical disk, coupled with the vehicle based data processing system 110 to persistently store information and instructions. The user profiles 140 can include properties, applications interacted with, systems interacted with, actions taken corresponding to a user's actions or behaviors in a vehicle 107. The vehicle based data processing system 110 can generate the user profiles 140 to include at least one of: a location profile, a pattern profile, or a history profile of the user of the vehicle 107.

The vehicle based data processing system 110 can include a prediction module 130 and a search module 135. The prediction module 130 can include at least one logic device such as a computing device or server having at least one processor to communicate via a network with one or more systems of the vehicle 107. The prediction module 130 can include a prediction algorithm to generate predicted actions or predicted content in the form of data structures 165 responsive to an input from a user of the vehicle 107. For example, the prediction module 130 can execute a prediction algorithm having a set of instructions to correlate user inputs with actions or content provided by one or more systems of the vehicle 107. For example, the prediction module 130 can receive identified applications or systems of the vehicle from a search module 135 of the vehicle based data processing system 110. The prediction module 130 can execute the prediction algorithm to identify actions or content corresponding to the identified applications or systems (e.g., call first contact though phone menu, set temperature to 70 degrees in vehicle through climate control menu). The actions or content can be generated based in part on a user profile 140 of the user of the vehicle 107 to identify actions the user typically takes or content the user typically requests. The prediction module 130 can data structures 165 including the actions or content. The prediction module 130 can generate confidence scores 145 for data structures 165 indicating a frequency of use or a likelihood the user will select the respective data structure 165. The vehicle based data processing system 110 or the prediction module 130 can generate output corresponding to the data structures 165. For example, the vehicle based data processing system 110 or the prediction module 130 can generate at least out output for each data structure 165. The output (e.g., first output and second output) can be generated by the vehicle based data processing system 110 can include an icon, text, image, visual output, audio output or a link to at least one menu (e.g., a phone menu, a navigation menu, an entertainment menu, a climate control menu), system or application 175 of the vehicle 107 to initiate or invoke an action using the respective menu, system or application 175 of the vehicle 107. The output can include an interaction tool provided to a user of the vehicle 170 through at least one display 155 or at least one display 155 of the search interface 160 for a user of the vehicle 107 to interact with or make selections to execute different actions using at least one menu (e.g., a phone menu, a navigation menu, an entertainment menu, a climate control menu), system or application 175 of the vehicle 107.

The search module 135 can include at least one logic device such as a computing device or server having at least one processor to communicate via a network with one or more systems of the vehicle 107. The search module 135 can generate data files 120 corresponding to identified applications or systems of the vehicle 107. For example, the search module 135 identify data files 120 responsive to an input from a user of the vehicle received via the search interface 160. The search module 135 can use the input to identify at least one application or at least one system corresponding to the input. For example, responsive to receiving an input regarding a song title, the search module 135 can identify the entertainment system of the vehicle. The search module 135 can generate a data file 120 identifying the entertainment system of the vehicle and provide the data file 120 to the prediction module 130.

The information cluster 105 can include a display module 150 having a plurality of displays 155 to provide a visual interface window for a user of the vehicle 107 to interact with the different systems or applications of the vehicle 107 from the single information cluster 105. For example, the user can be provided access to a search interface 160, a navigation menu, a climate control menu, an entertainment menu, an autonomous drive menu, or a phone menu through different displays of the display module 150. Thus, the information cluster 105 as described herein can reduce or eliminate the need for any specific button layout, independent hardware, independent software for each of the different systems of the vehicle 107 as they can be provided within the single information cluster 105 and share a common vehicle based data processing system 110. The information cluster 105 can provide a consistent and easily accessible control interface for any context the user may want to interface with in the vehicle 107 directly from, for example but not limited to, a console of the vehicle 107.

The display module 150 can provide content or data structures 165 corresponding to different systems of the vehicle 107 (e.g., climate control menu, entertainment menu, navigation menu) through the plurality of displays 155. Each of the displays 155 can display at least one data structure 165. At least one of display 155 of the plurality of displays 155 can be assigned to provide or otherwise display a search interface 160 generated by the vehicle based data processing system 110. For example, at least one display 155 of the plurality of displays 155 can be dedicated to display the search interface 160 when the vehicle 107 is active otherwise turned on, such that the search interface 160 is always visible to a user of the vehicle 107 when the vehicle 107 is active otherwise turned on. The search interface 160 can display at least one data structure 165 generated in response to an input from a user of the vehicle 107. The search interface 160 can provide search functionality to search different applications or systems of the vehicle 107.

The data structures 165 can be saved in a database (e.g., database 115) of the information cluster 105 or a database separate from but communicatively coupled with the information cluster 105. The data structures 165 can correspond to predicted actions or predicted content generated by the vehicle based data processing system in response to inputs from a user. The data structures 165 can correspond to or be linked with instructions to execute an action using at least one of the phone menu, the navigation menu, the entertainment menu, the climate control menu and the application 175. For example, the data structures 165 can include a data structure having a latitude value and a longitude value for a point of interest or geographical location corresponding to an input and using a navigation system (e.g., navigation menu) of the vehicle. The data structures 165 can include a data structure having a telephone number, a web address, email address or other forms of contact information corresponding to an input and using a phone system of the vehicle. The data structures 165 can correspond to or be linked with at least one output provided to a user of the vehicle 107. For example, the outputs can include an icon, text, image, visual output, audio output or a link to at least one menu (e.g., a phone menu, a navigation menu, an entertainment menu, a climate control menu), system or application 175 of the vehicle 107 to initiate or invoke an action using the respective menu, system or application 175 of the vehicle 107.

The data structures 165 can be linked with or include at least one link to an external server (e.g., servers 170) to request to retrieve content corresponding to an input from a user of the vehicle 107. For example, the vehicle based data processing system 110 can generate at least one hyperlink for each of the data structures 165. The vehicle based data processing system 110 can generate the data structures 165 such that each of the data structures 165can include a hyperlink or are tagged with a hyperlink to redirect a user of the vehicle from the information cluster 105 to a server (e.g., servers 170) corresponding to an input from a user of the vehicle 107. The data structures 165 can include action for or content from, for example, at least one of: a climate control menu, an entertainment menu, an autonomous drive menu, a navigation menu, and a phone menu. The data structures 165 can correspond to any system, component or element of the vehicle 107 or any system, component or element coupled with the vehicle 107 (e.g., cell phone, computing device, electronic key).

The vehicle 107 can include at least one system or at least one menu corresponding to a system or application of the vehicle 107, coupled with the vehicle 107 or executing within a network of the vehicle 107. For example, the vehicle can include a phone menu, a navigation menu, an entertainment menu, a climate control menu, an autonomous driving menu. The phone menu (or phone system) of the vehicle 107 can be implemented using hardware or a combination of software and hardware. For example, each component of the phone menu can include logical circuity (e.g., a central processing unit or CPU) that responses to and processes instructions fetched from a memory unit (e.g., memory 125). The navigation menu (or navigation system) of the vehicle 107 can be implemented using hardware or a combination of software and hardware. For example, each component of the navigation menu can include logical circuity (e.g., a central processing unit or CPU) that responses to and processes instructions fetched from a memory unit (e.g., memory 125). The entertainment menu (or entertainment system) of the vehicle 107 can be implemented using hardware or a combination of software and hardware. For example, each component of the entertainment menu can include logical circuity (e.g., a central processing unit or CPU) that responses to and processes instructions fetched from a memory unit (e.g., memory 125). The climate control menu (or climate control system) of the vehicle 107 can be implemented using hardware or a combination of software and hardware. For example, each component of the climate control menu can include logical circuity (e.g., a central processing unit or CPU) that responses to and processes instructions fetched from a memory unit (e.g., memory 125). The autonomous driving menu (or autonomous driving system) of the vehicle 107 can be implemented using hardware or a combination of software and hardware. For example, each component of the autonomous driving menu can include logical circuity (e.g., a central processing unit or CPU) that responses to and processes instructions fetched from a memory unit (e.g., memory 125).

The display module 150 can provide a visual output or an audio output from the vehicle based data processing system 110, the vehicle 107 or other forms of computing device content to a user of the vehicle 107 through the plurality of displays 155 and search interface 160. For example, the display module 150 can provide a visual feedback output from the vehicle based data processing system 110 to a user of the vehicle 107 through the plurality of displays 155 and search interface 160. The displays 155 and search interface 160 can include an electronic device for the visual presentation of data, such as but not limited to, data structures 165. The displays 155 and search interface 160 can include an interface, a screen, a digital window, or display device to provide a visual display to a user of the vehicle 107. The displays 155 and search interface 160 can correspond to portions of the display module 150 generated by the vehicle based data processing system 110. The display module 150, the plurality of displays 155 and search interface 160 can include a touch screen. For example, the display module 150, the plurality of displays 155 and search interface 160 can receive a contact or touch input via a screen of a respective display 155 or search interface 160. The display module 150, displays 155 or search interface 160 can generate a signal corresponding to the contact input. Thus, display module 150, displays 155 and search interface 160 can provide an interface for a user to interact with through contact.

The dimensions of the displays 155 and search interface 160 can vary based at least in part on a location within a vehicle 107 that the displays 155 and search interface 160 are disposed or provided. Each of the displays 155 (e.g., including the search interface 160) can have the same dimensions. One or more of the displays 155 (e.g., including the search interface 160) can have different (e.g., greater, less than) dimensions that one or more other displays 155. The dimensions of the displays 155 and the search interface 160 can be dynamically modified by the vehicle based data processing system 110. For example, the vehicle based data processing system 110 can generate the displays 155 and the search interface 160 for the display module 150. The vehicle based data processing system 110 can determine a number of displays 155 to provide within the display module 150 based in part on the dimensions of the display module 150 or a user of the vehicle. The vehicle based data processing system 110 can determine a number of displays 155 to dedicate to the search interface 160 based in part on the dimensions of the display module 150 or a user of the vehicle 107. The vehicle based data processing system 110 can determine dimensions (e.g., diameter, radius, length, width) of the displays 155 and the search interface 160. The vehicle based data processing system 110 can determine a number of pixels within the display module 150 to allocate to each of the displays 155 and the search interface 160. The dimensions or pixel value assigned to a display 155 or search interface 160 can be selected based at least in part on a data structure 165 to be provided within the respective display 155 or search interface 160. The vehicle based data processing system 110 can determine a position for each of the displays 155 and search interface 160 within the display module 150. The vehicle based data processing system 110 can determine which display 155 and how many displays 155 can be assigned to the search interface 160. The vehicle based data processing system 110 can generate and assign data structures 165 to each of the displays 155 and the search interface 160. The vehicle based data processing system 110 can position and relocate the data structures 165 between each of the displays 155 and search interface 160, for example, responsive to a user of the vehicle 107 or responsive to an input received through one of the displays 155 or search interface 160. For example, the vehicle based data processing system 110 can relocate or move a navigation menu from a first display 155 of the plurality of displays 155 to a second, different display 155 of the plurality of displays 155. The display module 150 can be disposed within or provided within various components of the vehicle 107. For example, but not limited to, the display module 150, the plurality of displays 155 and the search interface 160 can be disposed within or provided within a dashboard, a console, a steering wheel, or a seat (e.g., head rest, back portion) of the vehicle 107. The display module 150 can include two or more displays 155. The display module 150 can include a single display 155. The display module 150 can provide a visual or audio output from the vehicle based data processing system 110, the vehicle 107 or other forms of computing device content to a user of the vehicle 107.

The information cluster 105 can include or couple with at least one input device 180. The input device 180 can include a device, a human interface device, a computing device or computing element to receive and provide data and control signals to the vehicle based data processing system 110. The input device 180 can generate the control signal responsive to, but not limited to, a physical motion, mechanical motion, or audio input. For example, the input device 180 can generate a control signal responsive to contact (e.g., physical contact) with a surface of the input device 180. The input device 180 can generate the control signal responsive to, but not limited to, a touching, a pressing, a swipe motion or other forms of contact with the surface of the input device 180. The contact can include discrete contact or continuous contact. The input device 180 can include a keypad, a layout of buttons or group of buttons. For example, the buttons can generate a signal responsive to at least one of a contact input, a physical motion input, a mechanical motion input, and an audio input. The input device 180 can include two or more buttons. The input device 180 can include a single button. The buttons can include mechanical buttons (e.g., spring based buttons), digital buttons or virtual buttons. The input device 180 can be provided on or couple with different portions of the vehicle 107. For example, the input device 180 can be provided on or couple with a steering wheel, a console or a dashboard of the vehicle 107.

The information cluster 105 can couple with at least one server 170 that hosts or provides at least one application 175. The servers 170 can include remote servers or third party servers executing external to the vehicle 107 or the vehicle based data processing system 110. For example, the servers 170 may include an application delivery system for delivering an application 175, a computing environment, and/or data files to the vehicle based data processing system 110. The servers 170 can include HTTP servers or application servers. The servers 170 can correspond to vendors, stores, destinations, home address, schools, offices, shopping centers, coffee shops, grocery stores, or environmental destinations (e.g., park, lake, mountain). For example, the data structures 165 generated by the vehicle based data processing system 110 can be linked with at least one server 170 to retrieve content from or corresponding to an input received via the search interface 160. For example, a data structure 165 can identify a coffee shop responsive to a user input via the search interface 160 for a coffee shop. The coffee shop data structure 165 can be linked, for example, using a hyperlink, with a web address of the corresponding coffee shop hosted by at least one server 170. The vehicle based data processing system 110 can generate data structures 165 corresponding to different coffee hops within a geographical location of the vehicle 107. For example, responsive to an input from a user of the vehicle 107, the vehicle based data processing system 110 can generate a data structure 165 identifying a server 170 corresponding to or linked with (e.g., via a hyperlink) a coffee shop that user has previously ordered from through the information cluster 105. The vehicle based data processing system 110 can generate the data structures having a request or function 118 for a third party server 170. The function can cause a third party application 175 hosted by the third party server 170 to generate content corresponding to the input from the user of the vehicle 107. For example, the function can include a set of instructions to be executed by the third party server 170 to generate or retrieve content corresponding to an input from the user of the vehicle 107. In the coffee shop data structure 165 example, the function can include a set of instructions to cause the third party server 170 to retrieve menu data and price data for coffee supplied by the respective coffee shop. The vehicle based data processing system 110 can receive the content (e.g., coffee menu with coffee prices) and display the content within the information cluster 105 through at least one display 155.

The servers 170 can provide or host at least one application 175. The applications 175 can correspond to a point of service tool for a data structure 165. For example, the applications 175 can include a home page or web content corresponding to a data structure 165. The applications 175 may include web content, HTTP content or resources provided by or hosted by the servers 170. For example, the applications 175 may include network applications that are served from and/or hosted on the servers 170. The applications 175 can include an application 175 hosted on at least one server 170 accessed by the vehicle based data processing system 110 via a network. The applications 175 can include, but not limited to, a web application, a desktop application, remote-hosted application, a virtual application, a mobile application, an HDX application, a local application, or a native application (e.g., native to the vehicle based data processing system 110 or vehicle 107). The vehicle based data processing system 110 and the servers 170 can be communicatively coupled through a network, such as but not limited to, a public network, a wide area network (WAN) or the Internet. The network may be a private network such as a local area network (LAN) or a company Intranet. The network may employ one or more types of physical networks and/or network topologies, such as wired and/or wireless networks, and may employ one or more communication transport protocols, such as transmission control protocol (TCP), internet protocol (IP), user datagram protocol (UDP) or other similar protocols.

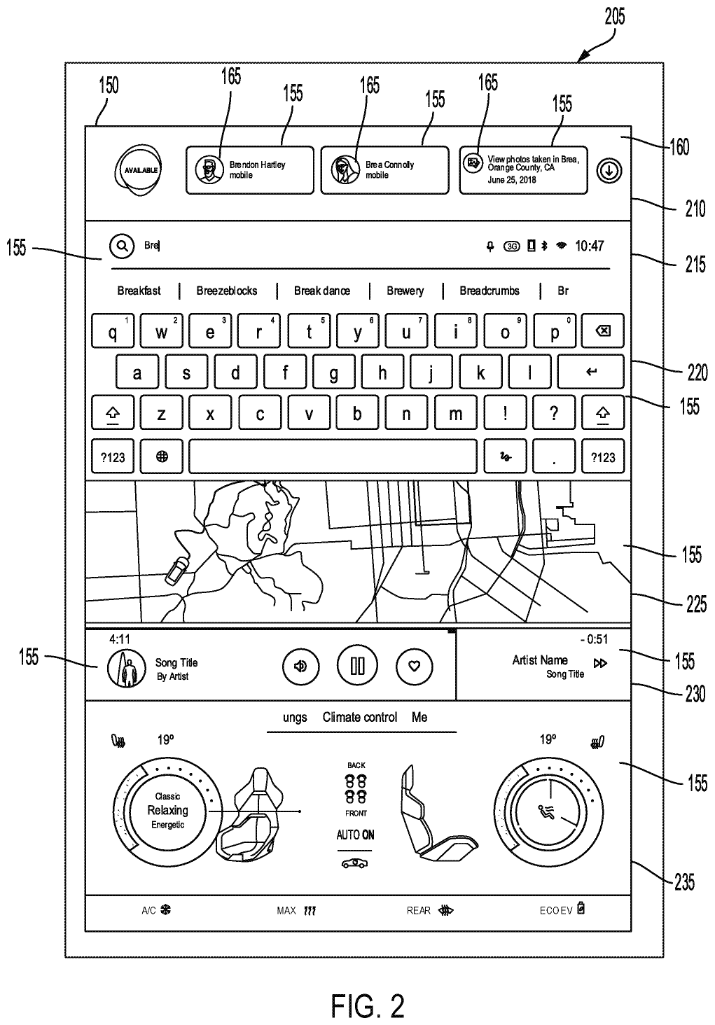

FIG. 2, among others, depicts a display module 150 of an information cluster 105 provided within a console 205 of a vehicle 107. The display module 150 can include a plurality of displays 150 to provide menus or applications corresponding to different systems of the vehicle 107 through a single consolidated display. For example, the display module 150 can include a first portion 210 providing a search interface 160 having multiple displays 155. Each of the multiple displays 155 dedicated to the search interface 160 can display at least one data structure 165. The display module 150 can include a second portion 215 having at least one display 155 to provide a search bar. The display module 150 can include a third portion 220 providing a touch screen keypad through at least one display 155. The display module 150 can include a fourth portion 225 providing a navigation menu through at least one display 155. The display module 150 can include a fifth portion 230 providing an entertainment menu through multiple displays 155. The display module 150 can include a sixth portion 235 providing a climate control menu through at least one display 155. Thus, the information cluster 105 can combine processing power of multiple systems (e.g., search interface, navigation menu, entertainment menu, climate control menu) into a single system to efficiently manage the allocation of computer resources within the vehicle 107.

The vehicle based data processing system 110 can generate a standard display layout for the information cluster 105. For example, when the vehicle 107 is turned on, the vehicle based data processing system 110 can initially display a standard display layout having a plurality of displays 155 and at least one display 155 dedicated to the search interface 160. The standard display layout can correspond to a factory setting or setting selected by a user or owner of the vehicle 107. The vehicle based data processing system 110 can generate a custom display layout or modify display layout properties responsive to inputs or interactions from a user of the vehicle 107. For example, the vehicle based data processing system 110 can generate custom display layouts that are unique to each user of the vehicle 107. The custom display layout settings can be stored in the memory 125 of the vehicle based data processing system. The vehicle based data processing system 110 can identify a user of the vehicle 107 when the vehicle is turned on and identify a custom display layout for the user of the vehicle 107. The vehicle based data processing system 110 can update or modify the custom display layout responsive to user inputs or user interactions with the respective custom display layout. For example, the vehicle based data processing system 110 can monitor which portion of the display module 150 the user prefers to the search interface 160 to be positioned at. The vehicle based data processing system 110 can update a user profile 140 of the respective user to reflect that the user prefers to have the search interface 160, for example, positioned with the first portion 210 of the display module 150. The vehicle based data processing system 110 can continually update or dynamically modify user profiles 140 to reflect user inputs or user interactions with a custom display layout corresponding to the user.

The dimensions of the displays 155 or portions 210, 215, 220, 225, 230, 235 can vary based at least in part on a location within a vehicle 107 that the information cluster 105 is disposed or provided. The vehicle based data processing system 110 can generate the displays 155 or portions 210, 215, 220, 225, 230, 235 having varying dimensions or the same dimensions to fit or position within the component of the vehicle the information cluster 105 is disposed within (e.g., console, dashboard). For example, the vehicle based data processing system 110 can generate the information cluster 105 having six displays 155 of varying dimensions. A first display 155 can have a height or length in a range from 1 inch to 4 inches (e.g., 1.7 inches) and a width in a range from 7 inches to 12 inches (e.g., 9 inches). A second display 155 can have a height or length in a range from 0.5 inches to 4 inches (e.g., 0.75 inches) and a width in a range from 7 inches to 12 inches (e.g., 9 inches). A third display 155 can have a height or length in a range from 2 inches to 6 inches (e.g., 5 inches) and a width in a range from 7 inches to 12 inches (e.g., 9 inches). A fourth display 155 can have a height or length in a range from 3 inches to 6 inches (e.g., 4.55 inches) and a width in a range from 7 inches to 12 inches (e.g., 9 inches). A fifth display 155 can have a height or length in a range from 3 inches to 5 inches (e.g., 4 inches) and a width in a range from 7 inches to 12 inches (e.g., 9 inches). A sixth display 155 can have a height or length in a range from 3 inches to 5 inches (e.g., 4 inches) and a width in a range from 7 inches to 12 inches (e.g., 9 inches). The height, length and width of the displays 155 can vary within or outside these ranges. The vehicle based data processing system 110 can generate the displays 155 based on or using pixel values. The vehicle based data processing system 110 can generate the displays 155 having varying heights or lengths and the same width. The vehicle based data processing system 110 can generate the displays 155 having the same height or length and varying widths. The vehicle based data processing system 110 can generate the displays 155 having varying heights or lengths and varying widths.

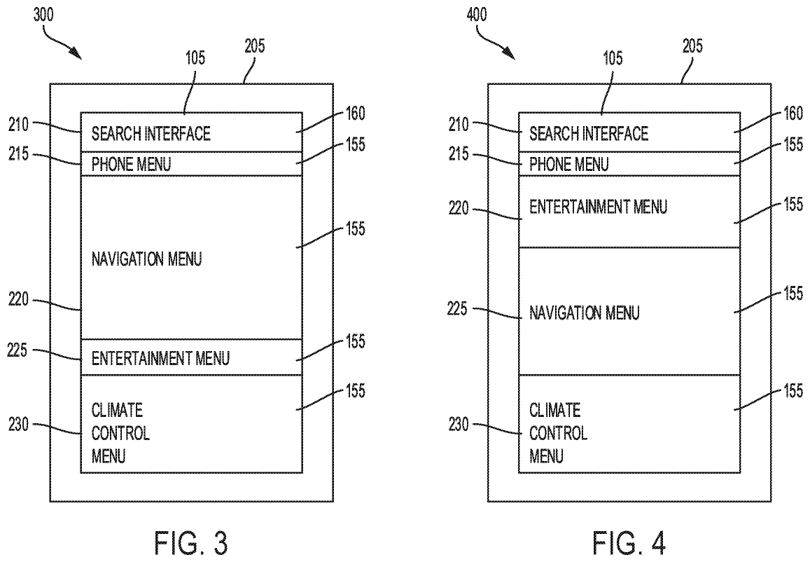

FIG. 3, among others, depicts a display layout 300 of an information cluster 105 provided within a console 205 of a vehicle 107. The display layout 300 (or display module 150) can include a plurality of portions to provide access to different applications or systems of the vehicle 107 from a single consolidated information cluster 105. For example, the display layout 300 can include a first portion 210 providing a search interface 160 and having a first set of dimensions. The search interface 160 can include or be allocated by the vehicle based data processing system 110 a plurality of displays 155 to provide data structures 165 (e.g., search interface 160 of FIG. 2). The display layout 300 can include a second portion 215 having at least one display 155 providing a phone menu. The vehicle based data processing system 110 can generate the second portion 215 having a first set of dimensions. The display layout 300 can include a third portion 220 having at least one display 155 providing a navigation menu. The vehicle based data processing system 110 can generate the third portion 220 having a first set of dimensions. The display layout 300 can include a fourth portion 225 having at least one display 155 providing an entertainment menu. The vehicle based data processing system 110 can generate the fourth portion 225 having a first set of dimensions. The display layout 300 can include a fifth portion 230 having at least one display 155 providing a climate control menu. The vehicle based data processing system 110 can generate the fifth portion 230 having a first set of dimensions.

The vehicle based data processing system 110 can generate the dimensions for each of the displays 155 based on a standard display layout settings or a custom display layout settings corresponding to a user of the vehicle 107. The dimensions can correspond to a length value, width value, diameter value, or a combination of a length value and a width value. The dimensions can correspond to a pixel value assigned or allocated to the displays 155 by the vehicle based data processing system. The vehicle based data processing system 110 can determine the dimensions based in part on the dimensions of the console 205 the information cluster 105 is provided within. The vehicle based data processing system 110 can determine the dimensions based in part on the dimensions of the portions 210, 215, 220, 225, 230 the respective display 155 is provided within. For example, the vehicle based data processing system 110 can generate each of the displays 155 such that the displays 155 are visible or at least partially visible within the vehicle 107 with respect to a viewpoint of a user of the vehicle 107. The vehicle based data processing system 110 can generate a set of instructions for the display module 150 corresponding to each display 155 to generate each of the displays 155 having the determined dimensions or pixel values. For example, the instructions can include the dimensions or pixel values for each of the displays 155 to be generated. The vehicle based data processing system 110 can generate each of the displays 155 having the same visibility (e.g., same dimensions, same pixel value). The vehicle based data processing system 110 can generate one or more of the displays 155 having a different visibility (e.g., same dimensions, same pixel value) from one or more other displays 155. For example, the vehicle based data processing system 110 can determine the dimensions or pixel value for a display 155 based in part on the content to be provided within the respective display 155. For example, the vehicle based data processing system 110 can generate the dimensions or pixel value for a display 155 providing a navigation menu to be larger or more visible as compared to a display 155 providing a phone menu. The display module 150 can receive the set of instructions from the vehicle based data processing system 110 and generate or provide each of the displays 155 using the instructions having the dimensions or pixel values for each of the displays 155 to be generated.

The vehicle based data processing system 110 can determine a position or location for content to be provided within the different portions 210, 215, 220, 225, 230 based in part on confidence scores 145. For example, the vehicle based data processing system 110 can determine confidence scores 145 for the different menus (e.g., search interface 160, phone menu, navigation menu, entertainment menu, climate control menu) based in part on at least one of: a time value, a location of the vehicle 107, a pattern profile of the user of the vehicle 107, and a user profile 140 of the user of the vehicle 107. The confidence scores 145 can correspond to a frequency of use or frequency of interaction with the respective menu. For example, the vehicle based data processing system 110 can determine a highest confidence score 145 or first confidence score 145 for the search interface 160. The vehicle based data processing system 110 can determine a second confidence score 145 (e.g., less than the first confidence score 145) for the phone menu. The vehicle based data processing system 110 can determine a third confidence score 145 (e.g., less than the second confidence score 145) for the navigation menu. The vehicle based data processing system 110 can determine a fourth confidence score 145 (e.g., less than the third confidence score 145) for the entertainment menu. The vehicle based data processing system 110 can determine a fifth confidence score 145 (e.g., less than the fourth confidence score 145) for the climate control menu. The vehicle based data processing system 110 can position the different menus based in part on the determined confidence score 145. For example, the vehicle based data processing system 110 can position the search interface 160 having the first confidence score 145 in the first portion 210. The vehicle based data processing system 110 can position the phone menu having the second confidence score 145 in the second portion 215. The vehicle based data processing system 110 can position the navigation menu having the third confidence score 145 in the third portion 220. The vehicle based data processing system 110 can position the entertainment menu having the fourth confidence score 145 in the fourth portion 225. The vehicle based data processing system 110 can position the climate control menu having the fifth confidence score 145 in the fifth portion 230. The vehicle based data processing system 110 can rank the menus based on the confidence scores 145. The vehicle based data processing system 110 can store the confidence scores 145 for each of the plurality of menus in entries in the memory 125.

FIG. 4, among others, depicts a display layout 400 of an information cluster 105 provided within a console 205 of a vehicle 107. The vehicle based data processing system 110 can modify the content provided within the different portions 210, 215, 220, 225, 230 of the information cluster 105 responsive to an interaction (e.g., user input, user selection) from a user of the vehicle 107. The vehicle based data processing system 110 can modify the dimensions or pixel value assigned to different portions 210, 215, 220, 225, 230 of the information cluster 105 responsive to an interaction (e.g., user input, user selection) from a user of the vehicle 107. For example, in FIG. 4, the vehicle based data processing system 110 can relocate the navigation menu from the third portion 220 in display layout 300 of FIG. 3 to a fourth portion 225 in the display layout 400 of FIG. 4 responsive to an interaction from a user of the vehicle 107. The vehicle based data processing system 110 can relocate the entertainment menu from the fourth portion 225 in display layout 300 of FIG. 3 to a third portion 220 in the display layout 400 of FIG. 4 responsive to an interaction from a user of the vehicle 107. For example, the interaction can correspond to a user selection of at least one data structure 165 provided within the search interface 160. The selected data structure 165 can correspond to a song choice. Thus, the vehicle based data processing system 110 can relocate the entertainment menu to portion 220 of the information cluster 105 preferred by the user of the vehicle 107. The vehicle based data processing system 110 can identify the user preferences by accessing a user profile 140 corresponding to the user of the vehicle 107. The vehicle based data processing system 110 generate instructions to relocate the entertainment menu from the fourth portion 225 to the third portion 220. The vehicle based data processing system 110 generate instructions to relocate the navigation menu from the third portion 220 to the fourth portion 225. The vehicle based data processing system 110 can execute the instructions to relocate the entertainment menu from the fourth portion 225 to the third portion 220 and relocate the navigation menu from the third portion 220 to the fourth portion 225.

The vehicle based data processing system 110 can modify the dimensions or pixel value for one or more portions 210, 215, 220, 225, 230 of the information cluster responsive to a user interaction (e.g., user input, user selection). For example, in FIG. 4, the dimensions of the third portion 220 and the fourth portion 225 can be modified. The dimensions of the third portion 220 providing the entertainment menu have been reduced to make the content provided within the display 155 allocated to the entertainment menu smaller as compared to the size of the third portion 220 in the display layout 300 of FIG. 3. The dimensions of the fourth portion 225 providing the navigation menu have been increased to make the display 155 allocated to the navigation menu larger as compared to the fourth portion 225 of the display layout 300 of FIG. 3. The vehicle based data processing system 110 can modify the dimensions based in part on a user preference retrieved from a user profile 140 of a user of the vehicle 107. The vehicle based data processing system 110 can modify the dimensions based in part on the content provided within the respective portion 210, 215, 220, 225, 230 of the information cluster 105. For example, the vehicle based data processing system 110 can determine that to properly display the navigation menu, the dimensions of the fourth portion 225 should be increased. Thus, responsive to relocating the navigation menu to the fourth portion 225, the vehicle based data processing system 110 can generate new dimensions or allocate a new pixel value to the fourth portion 225 providing the navigation menu.

The vehicle based data processing system 110 can generate a set of instructions to modify the dimensions of at least one portion 210, 215, 220, 225, 230 or at least one display 155. For example, the vehicle based data processing system 110 can generate a set of instructions to reduce the size of the third portion 220 providing the entertainment menu. The instructions to reduce the size of the third portion 220 (or any portion or any display 155) can include a new set of dimensions that include smaller dimensions (e.g., smaller width, smaller length, smaller diameter) as compared to the dimensions the third portion 220 was assigned in the display layout 300 of FIG. 3. The instructions to reduce the size of the third portion 220 (or any portion or any display 155) can include a new pixel value that includes less pixels than the pixel value assigned to the third portion 220 in the display layout 300 of FIG. 3. The vehicle based data processing system 110 can reduce the size of the third portion 220 by various amounts based in part on the size of the other portions 210, 215, 220, 225, 230 or other displays 155 within the information cluster 105. For example, the vehicle based data processing system 110 can reduce the size of the third portion 220 by 10%. The vehicle based data processing system 110 can reduce the third portion 220 by 50%. The vehicle based data processing system 110 can remove the third portion 220 or remove at least one portion from the information cluster 105 and thus, reduce the size of the third portion 220 or at least one portion by 100%. The vehicle based data processing system 110 can reduce the size of a portion 210, 215, 220, 225, 230 or a display 155 in the display module 150 in a range from 5% to 100%.

The vehicle based data processing system 110 can generate a set of instructions to increase the dimensions of at least one portion 210, 215, 220, 225, 230 or at least one display 155. The vehicle based data processing system 110 can generate a set of instructions to increase the size of the fourth portion 225 providing the navigation menu. The instructions to increase the size of the fourth portion 225 (or any portion or any display 155) can include a new set of dimensions that include larger dimensions (e.g., greater width, greater length, greater diameter) as compared to the dimensions the fourth portion 225 was assigned in the display layout 300 of FIG. 3. The instructions to increase the size of the fourth portion 225 (or any portion 225 or any display 155) can include a new pixel value that includes more pixels than the pixel value assigned to the fourth portion 225 in the display layout 300 of FIG. 3. The vehicle based data processing system 110 can increase the size of the fourth display 155 by various amounts based in part on the size of the other portions 210, 215, 220, 225, 230 or other displays 155 within the information cluster 105. For example, the vehicle based data processing system 110 can increase the size of the fourth portion 225 by 10%. The vehicle based data processing system 110 can increase the size of the fourth portion 225 by 50%. The vehicle based data processing system 110 can add the fourth portion 225 or add at least one portion to the information cluster 105 and thus, increase the size of the fourth portion 225 by 100%. The vehicle based data processing system 110 can increase the size of a portion 210, 215, 220, 225, 230 or a display 155 in the information cluster 105 in a range from 5% to 100%.

The vehicle based data processing system 110 can modify the dimensions or pixel value for one or more portions 210, 215, 220, 225, 230 or displays 155 responsive to an input or interaction from a user of the vehicle 107. The interaction can include a new user entering the vehicle 107, a touch input through at least one display 155, an input through an input device 180 of the vehicle 107 or a voice command. For example, in FIG. 4, the display layout 400 can include a first portion 210 providing the search interface 160 and having the first set of dimensions from the display layout 300 of FIG. 3. The display layout 400 can include the second portion 215 having at least one display 155 providing the phone menu. The vehicle based data processing system 110 can generate the second portion 215 having the first set of dimensions from the display layout 300 of FIG. 3. The display layout 400 can include the third portion 220 having at least one display 155 providing the entertainment menu. The vehicle based data processing system 110 can generate the third portion 220 having a second set of dimensions that are different from the first set of dimensions from the display layout 300 of FIG. 3. The display layout 400 can include the fourth portion 225 having at least one display 155 providing the navigation menu. The vehicle based data processing system 110 can generate the fourth portion 225 having a second set of dimensions that are different from the first set of dimensions from the display layout 300 of FIG. 3. The display layout 400 can include the fifth portion 230 having at least one display 155 providing the climate control menu. The vehicle based data processing system 110 can generate the fifth portion 230 having the first set of dimensions from the display layout 300 of FIG. 3. Thus, the dimensions of the third portion 220 and the fourth portion 225 can be modified by the vehicle based data processing system 110. The vehicle based data processing system 110 can modify the dimensions by decreasing a size of the third portion 220 providing the entertainment menu and increasing a size of the fourth portion 225 providing the navigation menu. For example, the vehicle based data processing system 110, responsive to an input or interaction, can generate instructions to decrease the size of the third portion 220 providing the entertainment menu and increase the size of the fourth portion 225 providing the navigation menu. The vehicle based data processing system 110, responsive to an input or interaction, can generate instructions to decrease the pixel value allocated to the third portion 220 providing the entertainment menu and increase the pixel value allocated to the fourth portion 225 providing the navigation menu. The vehicle based data processing system 110 can apply the instructions to the third portion 220 and the fourth portion 225. The vehicle based data processing system 110 can store the instructions in the memory 125 for later use or to update a user profile 140 of a user that requested the modification to the display layout 400.

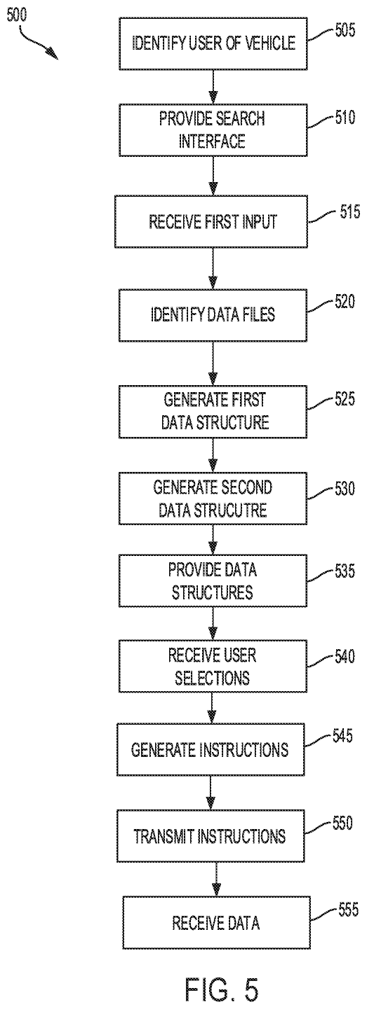

FIG. 5, among others, depicts a method 500 for providing data structures 165 to a search interface 160 of a consolidated vehicle information cluster 105. The method 500 can include identifying a user of the vehicle 107 (ACT 505). The vehicle 107 can include an information cluster 105 having a vehicle based data processing system 110. The vehicle based data processing system 110 can determine at least one user of the vehicle 107. For example, responsive to activating or turning on the vehicle or activating the information cluster 105, the vehicle based data processing system 110 can determine how many users are in the vehicle 107 and properties of the users (or user) in the vehicle 107. A user can refer to a driver or passenger in the vehicle 107. The vehicle based data processing system 110 can couple with one or more sensors within the vehicle to determine how many users are in the vehicle 107. For example, the seats in the vehicle can include sensors and the sensors can transmit a signal to the vehicle based data processing system 110 to indicate when a user is sitting in or on the respective seat. The vehicle based data processing system 110 can use the seat data to identify whether the user is a driver or passenger of the vehicle 107 or a combination of a driver and one or more passengers of the vehicle 107.

The vehicle based data processing system 110 can detect the presence or couple with one or more devices of a user of the vehicle 107 to detect the user of the vehicle 107. For example, the vehicle based data processing system 110 can detect the presence of a cell phone or hand held computing device and identify a user of the cell phone or hand held computing device. The vehicle based data processing system 110 can detect the presence of a key, electronic key, or key fob of the vehicle 107. The vehicle based data processing system 110 can use the device data to identify the corresponding user of the device. For example, the vehicle based data processing system 110 can receive user data from the device when the device couples with the information cluster 105. The vehicle based data processing system 110 can store user profiles 140 and use the device data to identify the user of the respective device.

The method 500 can include providing a search interface 160 (ACT 510). For example, the method 500 can include providing, by a vehicle based data processing system 110, a search interface 160. The search interface 160 can be provided within a first display 155 of a display module 150 of the vehicle 107. The vehicle based data processing system 110 can provide a plurality of displays 155 for a display module 150 visible within a vehicle 107. The display module 150 can communicatively couple with the vehicle based data processing system 110 to receive signals or transmit signals. The vehicle based data processing system 110 can generate a single display 155 for the display module 150. The vehicle based data processing system 110 can generate two or more displays 155 for the display module 150. The vehicle based data processing system 110 can dedicate or assign at least one display 155 for the search interface 160. The vehicle based data processing system 110 can dedicate or assign multiple displays 155 (e.g., two or more displays 155) for the search interface 160.

The vehicle based data processing system 110 can determine a number of displays 155 for the search interface 160 based in part on the identified user of the vehicle 107. For example, the user may have a preferred display layout stored in a user profile 140 corresponding to the user. The preferred display layout can include the number of displays 155 the user prefers for the search interface 160. Responsive to identifying the user of the vehicle 107, the vehicle based data processing system 110 can retrieve the preferred display layout for the user and generate a number of display 155 for the search interface 160 corresponding to the preferred display layout. The preferred layout can identify a preferred position within the display module 150 for the search interface 160. For example, the display module can include multiple portions (e.g., top portion, middle portion, bottom portion), with each portion allocated at least one display 155. The preferred layout can identify that the user prefers to the have the search interface 160 in a first portion or top portion of the display module 150. The preferred layout can identify that user prefers to the have the search interface 160 in a first portion or top portion of the display module 150. The vehicle based data processing system 110 can generate a position or location for the search interface 160 within the display module 150 using the preferred layout. The vehicle based data processing system 110 can determine a number of displays 155 for the search interface 160 based in part on a standard display layout. For example, the display module 150 can include a standard display layout having a predetermined number of displays 155 for the search interface 160 that the vehicle based data processing system 110 generates when the vehicle 107 is activated or turned on. The standard layout can identify a standard position within the display module 150 for the search interface 160. The vehicle based data processing system 110 can generate a position or location for the search interface 160 within the display module 150 using the standard layout.

The vehicle based data processing system 110 can generate the displays 155 such that each of the displays 155 can be visible or at least partially visible within the vehicle 107 with respect to a viewpoint of a user of the vehicle 107. For example, the vehicle based data processing system 110 can generate each of the displays 155 for the search interface 160 having the same visibility (e.g., same dimensions, same pixel value). The vehicle based data processing system 110 can generate one or more of the displays 155 for the search interface 160 having a different visibility (e.g., same dimensions, same pixel value) from one or more other displays 155. For example, the vehicle based data processing system 110 can generate a first display 155 of the search interface 160 having a greater visibility within the vehicle 107 than the other displays 155 of the search interface or of the display module 150. For example, the first display 155 of the search interface 160 can have a larger diameter or be assigned more pixels than the other displays 155 of the search interface 60 or of the display module 150.

The method 500 can include receiving a first input (ACT 515). For example, the method 500 can include obtaining, from the search interface 160, a first input from a user of the vehicle 107. The input (or inputs) can be received from a driver of the vehicle 107. The input (or inputs) can be received from a passenger or occupant of the vehicle 107. The input (or inputs) can be received from multiple passengers or multiple occupants of the vehicle 107. The input can be received through at least one display 155 of the search interface 160. For example, the displays 155 of the display module 150 can include or correspond to a touch screen. The display 155 allocated to the search interface 160 can include or present a search bar (e.g., search field, search box) and a touch screen keypad to a user of the vehicle 107. The search bar can include a graphical element provided within the display 155 presenting a text box or search icon to receive text (e.g., alphanumeric text, symbols). The display 155 can receive text entered by a user of the vehicle 107 through the touch screen keypad and the search bar of the display 155. The display 155 can couple with the vehicle based data processing system 110 to provide the entered text entered by a user of the vehicle 107. The text can correspond to an application or system of the vehicle 107. The vehicle based data processing system 110 can process the text to identify an application or system of the vehicle 107 corresponding to the text.

The vehicle based data processing system 110 can identify a touch signal corresponding to the interaction or input. The touch signal can represent of a position within a first display 155 of the display module 150 dedicated to the search interface 160. The touch signal can be responsive to contact with the position within the first display 155. The position can correspond to a text or icon provided within the display 155. The text or icon can correspond to an application or system of the vehicle 107. The text or icon can correspond to one or more properties stored in a user profile 140 for a user of the vehicle 107. For example, the text or icon can correspond to a song to play, a number to call, a location to drive to, and a setting for a component of the vehicle (e.g., temperature). The displays 155 can receive an input through contact with a surface of the respective display 155. The vehicle based data processing system 110 can detect a horizontal and vertical orientation of the contact on the display 155. The vehicle based data processing system 110 can map or identify the location of the contact using the horizontal and vertical orientation data. The vehicle based data processing system 110 can determine what text or icon is provided within the identified location of the contact.

The input can be received through an input device 180 of the information cluster 105. For example, the input device 180 can communicatively couple with the vehicle based data processing system 110, for example, through a wireless connection. The input device 150 can couple with the vehicle based data processing system 110, for example, through a wired connection. The input device 180 can include buttons or keypads to generate a signal responsive to contact. The signals can correspond to a directional input or motion input to interact with text or icons provided within a respective display 155. The signals can correspond to text entered by a user of the vehicle 107 through the input device 180. The signals can include a selection of a text or icon provided within a display 155. For example, the signals can include a text phrase entered through the input device 180 to request a particular song be played through an entertainment menu of the vehicle 107. The signals can include a direction (e.g., right, left, up, down) to relocate or slide content provided within a display 155. For example, the signals can include an instruction to scroll through an entertainment menu provided in a display 155 to find a song to play through the entertainment system of the vehicle 107.

The method 500 can include identify data files (ACT 520). For example, the method 500 can include identifying, by the search module 135 and responsive to the first input, a first data file 120 and a second data file 120. The first data file 120 and the second data file 120 can be identified from at least one of a phone menu, a navigation menu, an entertainment menu, a climate control menu and an application 175 hosted by a server 170. The vehicle based data processing system 110 can generate instructions for the search module 135 to generate at least one data file 120. The vehicle based data processing system 110 can provide the instructions to the search module 135 to execute the search module 135 to identify at least one data file 120 corresponding to the first input from the user of the vehicle. The vehicle based data processing system 110 can execute the search module 135 to identify a plurality of data files 120 corresponding to the first input from the user of the vehicle. The data files 120 can include a text entry or selected icon received through at least one display 155 of the search interface 160.

The data files 120 can include a search term or search phrase generated by the search module 135 in response to an input form a user of the vehicle 107. For example, the user can enter the text “Bre” into at least one display 155 of the search interface 160. The search module 135 can identify one or more data files 120 corresponding to the text “Bre.” The data files 120 can include names beginning with or including the text “Bre.” The data files 120 can include locations, points of interest or stores beginning with or including the text “Bre.” The data files 120 can include songs, artists or albums beginning with or including the text “Bre.” The data files 120 identified by the search module 135 can be identified based on the different applications or systems of the vehicle 107 (e.g., phone menu, navigation menu, entertainment menu). The identified data files 120 can be identified or generated by the search module 135 using the properties stored in user profiles 140 of the one or more users of the vehicle 107. For example, the search module 135 can access and use properties from a single passenger of the vehicle 107. The search module 135 can access and use properties from multiple passengers of the vehicle 107. The search module 135 can identify which user (e.g., driver or at least one passenger) entered the search term and retrieve the user profile 140 corresponding to that user.

The vehicle based data processing system 110 can generate at least one user profile 140 for at least one user (e.g., driver, passenger) within the vehicle. The vehicle based data processing system 110 can track or monitor the behavior of the user (e.g., user inputs, user selections) to generate a user profile 140 for a user of the vehicle 107. Thus, the user profile 140 can include properties, applications interacted with, systems interacted with, actions taken corresponding to a user's actions or behaviors in a vehicle 107. The vehicle based data processing system 110 can generate a plurality of data files 120 for the user profile 140 of the at least one user (e.g., driver, passenger) within the vehicle 107. The user profile 140 can include at least one of: a location profile, a pattern profile, or a history profile of the user of the vehicle 107.

The method 500 can include generating a first data structure (ACT 525). For example, the method 500 can include generating, by the prediction module 130 and from the first data file 120, a first data structure 165. The first data structure 165 can correspond to a first action to be executed using at least one of the phone menu, the navigation menu, the entertainment menu, the climate control menu and the application 175. The first action can include an action performed by a system (e.g., menu) of the vehicle 107 or an application 175 hosted by a server 170. The first action can include, for example, playing a song, calling a contact, diving to a particular location, a temperature setting of a climate control menu, or a mobile application 175 provided by a server 170. The vehicle based data processing system 110 can generate instructions for the prediction module 130 to generate at least one data structure 165. The vehicle based data processing system 110 can provide the instructions to the prediction module 130 to execute the prediction module 130 and generate at least one data structure 165 based on at least one data file 120. The data structure 165 can include a predicted content generated by the prediction module 130 and based on at least one data file 120. The data structure 165 can include a predicted action or predicted system of the vehicle based on at least one data file 120. For example, and using the data files 120 identified based on the search text “Bre,” the prediction module 130 can receive the data files 120 from the search module 135. A first data file 120 can identify at least one name beginning with or including the text “Bre.” The prediction module 130 can generate a first data structure 165 corresponding to a phone number for at least one contact (e.g., Brendan) of a user of the vehicle 107. The first data structure 165 can include a link to the phone menu of the vehicle 107 to initiate a call to the identified contact responsive to a user selection. The first data structure 165 can include an output provided to a user of the vehicle 107 through at least one display 155 of the search interface 160. For example, a prediction module 130 can generate a first output corresponding to the first data structure 165. The first output corresponding to the first data structure can include an icon, text, image, visual output, audio output or a link to at least one menu, system or application 175 of the vehicle 107 to initiate or invoke an action using the respective menu, system or application 175 of the vehicle 107. For example, the first output can include a link to the phone menu of the vehicle 107 to initiate a call to the identified contact responsive to a user selection.

The method 500 can include generating a second data structure (ACT 530). For example, the method 500 can include generating, by the prediction module 130 and from the second data file 120, a second data structure 165. The second data structure 165 can correspond to a second action to be executed using at least one of the phone menu, the navigation menu, the entertainment menu, the climate control menu and the application. The second action can include an action performed by a system (e.g., menu) of the vehicle 107 or an application 175 hosted by a server 170. The second action can include, for example, playing a song, calling a contact, diving to a particular location, a temperature setting of a climate control menu, or a mobile application 175 provided by a server 170. The vehicle based data processing system 110 can generate instructions for the prediction module 130 to generate a second data structure 165 or multiple data structures 165. The vehicle based data processing system 110 can provide the instructions to the prediction module 130 to execute the prediction module 130 and generate the second data structure 165 or multiple data structures based on at least one data file 120. The second data structure 165 can be based on and generated using a different data file 120 from the data file 120 used to generate the first data structure 165. The second data structure 165 can be based on the same or similar data files 120 as the first data structure 165. The second data structure 165 can correspond to a different prediction using the same application or system of the vehicle as compared to the application or system of the vehicle 107 used to generate the first data structure 165. The second data structure 165 can correspond to a different prediction using at least one different application or system of the vehicle as compared to the application or system of the vehicle 107 used to generate the first data structure 165. For example, and using the data files 120 identified based on the search text “Bre,” the prediction module 130 can receive the data files 120 from the search module 135. A second data file 120 can identify at least one name beginning with or including the text “Bre.” The prediction module 130 can generate a second data structure 165 corresponding to a location of at least one store (e.g., Breakfast Place) stored in a user profile 140 of a user of the vehicle 107. The second data structure 165 can include a link to contact information (e.g., phone number, application 175) to place an order to view a menu of the respective store using the information cluster 105. The second data structure 165 can include an output provided to a user of the vehicle 107 through at least one display 155 of the search interface 160. For example, a prediction module 130 can generate a second output corresponding to the second data structure 165. The second output corresponding to the second data structure can include an icon, text, image, visual output, audio output or a link to at least one menu, system or application 175 of the vehicle 107 to initiate or invoke an action using the respective menu, system or application 175 of the vehicle 107. For example, the second output can include a link to contact information (e.g., phone number, application 175) to place an order to view a menu of the respective store using the information cluster 105. The prediction module 130 can generate a third or multiple data structures 165 using the data files based on the text “Bre.” For example, the prediction module 130 can generate a third data structure 165 corresponding to a music artist (e.g., artist named Brea) stored in a user profile 140 of a user of the vehicle 107. The third data structure 165 can include a link to the entertainment menu to play a song from the identified artist. The prediction module 130 can generate a third or multiple outputs corresponding to a third or multiple structures 165 using the data files based on the text “Bre.” For example, the prediction module 130 can generate a third data structure 165 corresponding to a music artist (e.g., artist named Brea) stored in a user profile 140 of a user of the vehicle 107. The third data structure 165 can include a link to the entertainment menu to play a song from the identified artist. The prediction module 130 can generate a third output corresponding to a music artist (e.g., artist named Brea) stored in a user profile 140 of a user of the vehicle 107. The third output can include a link to the entertainment menu to play a song from the identified artist.

The prediction module 130 can generate multiple data structures 165 corresponding to multiple data files 120 generated by the search module 135. The prediction module 130 can generate multiple outputs corresponding to multiple data structures 165 generated by the search module 135. The number of data structures 165 generated can be based in part on a number of displays 155 allocated to the search interface 160. For example, if the vehicle based data processing system 110 allocates five displays 155 to the search interface 160, the prediction module 130 can generate five data structures 165. The number of data structures 165 generated can be based in part on a number of data files 120 generated by the search module 135 in response to an input. For example, if the search module 135 generates four data files 120, the prediction module 130 can generate four data structures 165.

The prediction module 130 can generate the data structures 165 based in part of one or more users of the vehicle 107, a user profile 140, a time of day, a location of the vehicle 107, or a device coupled with the vehicle based data processing system 110. The data structures 165 can correspond to, for example, a climate control menu, an entertainment menu, an autonomous drive menu, a navigation menu, or a phone menu. The prediction module 130 can generate the data structures 165 based in part on a relevance to the user or users of the vehicle 107. For example, the prediction module 130 can identify and select the most relevant or most important properties included within a user profile 140 corresponding to the user or users of the vehicle 107. The prediction module 130 can determine the relevance based at least in part on a frequency of use, time of day or properties of a user profile corresponding to the one or more users in the vehicle 107. For example, the prediction module 130 can extract data from the user profile 140 that the corresponding user interacts with the most or has previously interacted with. The user profile 140 can include properties ranked within the user profile 140 based in part on frequency of use.

The method 500 can include providing the data structures 165 (ACT 535). For example, the method 500 can include generating, by the vehicle based data processing system 110, a first output corresponding to the first data structure 165 and a second output corresponding to the second data structure 165. The method 500 can include providing, by the vehicle based data processing system 110, the first output and the second output for concurrent display by the search interface 160. The output (e.g., first output and second output) generated by the vehicle based data processing system 110 can include an icon, text, image, visual output, audio output or a link to at least one menu (e.g., a phone menu, a navigation menu, an entertainment menu, a climate control menu), system or application 175 of the vehicle 107 to initiate or invoke an action using the respective menu, system or application 175 of the vehicle 107. The output can include an interaction tool provided to a user of the vehicle 170 through at least one display 155 or at least one display 155 of the search interface 160 for a user of the vehicle 107 to interact with or make selections to execute different actions using at least one menu (e.g., a phone menu, a navigation menu, an entertainment menu, a climate control menu), system or application 175 of the vehicle 107. For example, a first output can include a link to the phone menu of the vehicle 107 to initiate a call to the identified contact responsive to a user selection of the first output. A second output can include a link to execute the navigation menu to provide directions to a location corresponding to at least one data structure 165 responsive to a user selection of the second output.

The method 500 can include providing, by the vehicle based data processing system 110, the first data structure 165 and the second data structure 165 in the forms of first and second outputs respectively for concurrent display by the search interface 160. The vehicle based data processing system 110 can display at least one output corresponding to at least one data structure 165 within at least one display 155 of the search interface 160. The vehicle based data processing system 110 can display multiple outputs corresponding to multiple data structures 165 within multiple displays 155 of the search interface 160. The vehicle based data processing system 110 can display at least one data structure 165 within at least one display 155 of the search interface 160. The vehicle based data processing system 110 can display multiple data structures 165 within multiple displays 155 of the search interface 160. The number of outputs displayed to a user of the vehicle 107 can correspond to the number of data structures 165 generated by the prediction module 130. The number of data structures 165 displayed to a user of the vehicle 107 can correspond to the number of data structures 165 generated by the prediction module 130. For example, if the prediction module 130 generates six data structures 165, the vehicle based data processing system 110 can generate instructions to display the six data structures 165 in six displays 155 allocated to the search interface 160. The vehicle based data processing system 110 can generate instructions to display the data structures 165 concurrently or simultaneously with the multiple displays 155 of the search interface 160. The vehicle based data processing system 110 can generate instructions to display the data structures 165 sequentially or one after another with the multiple displays 155 of the search interface 160. For example, the vehicle based data processing system 110 can assign weights to the data structures 165 generated by the prediction module 130. The weights can be selected based in part on a relevance to one or more properties of a user profile 140 of a user of the vehicle 107. For example, the more relevant or more frequently used, the higher weight value the respective property (e.g., song choice) and respective data structure 165 corresponding to the property can be assigned. The vehicle based data processing system 110 can generate instructions to display the data structures sequentially to a user of the vehicle 107 based on the assigned weight values. For example, a first data structure 165 having a first weight value that is greater than the weight values of other data structures 165 can be displayed first through at least one display 155 of the search module 160. The user of the vehicle 107 can be given the option of selection the first data structure 165 or scrolling through the data structures 165. The vehicle based data processing system 110 can display a second data structure 165 having a second weight value (e.g., the second weight value less than the first weight value) responsive to a user interaction with the display 155 providing the first data structure 165. For example, an input corresponding to a scroll motion or swipe motion can be received through the display 155 providing the first data structure 165. Responsive to the scroll motion or swipe motion, the vehicle based data processing system 110 can generate instructions to display a second data structure 165 or a different data structure 165 that is different from the first data structure 165. The vehicle based data processing system 110 can sequentially provide data structures 165 to a user of the vehicle 107 selects at least one data structure 165.

The vehicle based data processing system 110 can determine dimensions (e.g., length, width, diameter) of the displays 155 dedicated to the search interface 160. The dimensions can be selected based in part on the dimensions or shape of the display module 150 provided within the information cluster 105. The dimensions can be selected based in part on the location of the information cluster 105 (e.g., within a console, within a dashboard). The vehicle based data processing system 110 can dynamically modify the dimensions for the displays 155 dedicated to the search interface 160. For example, responsive to an interaction or input from a user of the vehicle 107, the vehicle based data processing system 110 can dynamically increase the size or dynamically increase at least one of a length value, a width value, a diameter value, or a combination of length and width values for the display 155 dedicated to the search interface 160. Responsive to an interaction or input from a user of the vehicle, the vehicle based data processing system 110 can dynamically decrease the size or dynamically decrease at least one of a length value, a width value, a diameter value, or a combination of length and width values for the displays 155 dedicated to the search interface 160. The vehicle based data processing system 110 can determine a number of pixels (e.g., pixel value) to be allocated or assigned to the displays 155 dedicated to the search interface 160. The vehicle based data processing system 110 can dynamically modify the pixel value for the displays 155 dedicated to the search interface 160. For example, responsive to an interaction or input from a user of the vehicle 107, the vehicle based data processing system 110 can dynamically increase the size or dynamically increase the pixel value for the display 155 dedicated to the search interface 160. Responsive to an interaction or input from a user of the vehicle, the vehicle based data processing system 110 can dynamically decrease the size or dynamically decrease the pixel value for the displays 155 dedicated to the search interface 160. For example, the vehicle based data processing system 110 can modify a size of the display 155 providing the search interface 160 responsive to an interaction or the input.

The dimensions of the displays 155 providing the data structures 165 can be modified (e.g., increased) to make the respective displays 155 appear more prominently to a user of the vehicle 107 (e.g., increase the visibility). For example, responsive to the providing the data structures 165, the vehicle based data processing system 110 can generate instructions to increase a size or visibility of the displays 155 of the search interface 160. The number of pixels allocated to the respective displays 155 can be increased to make the data structures 165 appear more prominently to a user of the vehicle 107 (e.g., increase the visibility). The dimensions of the displays 155 of the search interface 160 can be decreased to make the data structures 165 appear less prominent to a user of the vehicle 107 (e.g., increase the visibility) or to increase the visibility of other displays 155 of the display module 150. For example, responsive to a selection of at least one data structure 165, the vehicle based data processing system can generate instructions to decrease a size or visibility of the displays 155 of the search interface 160. The number of pixels allocated to the respective displays 155 can be decreased to make the data structures 165 appear more less visible to a user of the vehicle 107 (e.g., increase the visibility) as compared to other displays 155 of the display module 150.

The vehicle based data processing system 110 can modify a position or location of data structures 165 within the displays 155 dedicated to the search interface 160 responsive to an input or interaction. For example, the input can correspond to an instruction to move a first data structure 165 from a first display 155 to a second or third display 155 of the search interface 160. The vehicle based data processing system 110 can generate an instruction to relocate the first data structure 165 from the first display 155 of the search interface 160 to the third display 155 of the search interface 160. The vehicle based data processing system 110 can generate an instruction to relocate the first data structure 165 providing within the third display 155 of the search interface 160 to a first display 155 of the search interface 160. Thus, the vehicle based data processing system 110 can customize the display layout for a user of the vehicle 107 responsive to one or more interactions by the respective user.

The vehicle based data processing system 110 can arrange the data structures 165 based in part on confidence scores 145. For example, the vehicle based data processing system 110 can determine confidence scores 145 for data files 120 and data structures 165 based in part on at least one of: a time value, a location of the vehicle 107, a pattern profile of the user of the vehicle 107, and a user profile 140 of the user of the vehicle 107. The confidence scores 145 can correspond to a frequency of use or frequency of interaction with the respective data file 120 or data structure 165. The vehicle based data processing system 110 can select which display 155 of the search interface 160 will display which data structure 165 based on the confidence scores 145. For example, the vehicle based data processing system 110 can arrange the data structures 165 in order from highest confidence score 145 to lowest confidence score 145 of the data structures 165 selected to be displayed within the search interface 160. The vehicle based data processing system 110 can arrange the data structures 165 in a left to right direction with the left most display 155 providing the data structure 165 with the highest confidence score 145 and the right most display 155 providing the data structure 165 with the lowest confidence score 145 of the confidence scores 145 of the data structures 165 selected for display within the search interface 160. The vehicle based data processing system 110 can arrange the data structures 165 in a right to left eft to direction with the right most display 155 providing the data structure 165 with the highest confidence score 145 and the left most display 155 providing the data structure 165 with the lowest confidence score 145 of the confidence scores 145 of the data structures 165 selected for display within the search interface 160. The vehicle based data processing system 110 can arrange the data structures 165 in a top to bottom direction with the top or first display 155 providing the data structure 165 with the highest confidence score 145 and the bottom or last right display 155 providing the data structure 165 with the lowest confidence score 145 of the confidence scores 145 of the data structures 165 selected for display within the search interface 160. The vehicle based data processing system 110 can arrange the data structures 165 in a bottom to top direction with the bottom or last display 155 providing the data structure 165 with the highest confidence score 145 and the top or first display 155 providing the data structure 165 with the lowest confidence score 145 of the confidence scores 145 of the data structures 165 selected for display within the search interface 160. The arrangement of the data structures 165 can vary beyond these examples. The arrangement of the data structures 165 can be generated by the vehicle based data processing system based in part on the dimensions and layout of the information cluster 105.

The vehicle based data processing system 110 can determine a confidence score 145 for a first data structure 165 and a second data structure 165 of a plurality of data structures 165 selected for display within the search interface 160. The vehicle based data processing system 110 can arrange the first data structure 165 and the second data structure 165 within the search interface 160 based on the confidence score 145 of the first data structure 165 and the confidence score 145 of the second data structure 165. For example, the first data structure 165 can be assigned a first confidence score 145 and the second data structure 165 can be assigned a second confidence score 145. The first confidence score 145 can be higher than or greater than the second confidence score 145. The vehicle based data processing system 110 can generate instructions to display the first data structure 165 in a first display 155 allocated to the search interface 160 responsive to the first confidence score 145. The vehicle based data processing system 110 can generate instructions to display the second data structure 165 in a second display 155 allocated to the search interface 160 responsive to the second confidence score 145.

The vehicle based data processing system 110 can arrange data structures 165 based in part on a user of the vehicle 107. For example, the vehicle based data processing system 110 can determine a user of the vehicle 107. The search interface 160 can obtain a second input from the user of the vehicle 107. The vehicle based data processing system can generate confidence scores 145 for a plurality of data structures 165 corresponding to the user of the vehicle 107. For example, the vehicle based data processing system 110 can identify a user profile 140 of the user of the vehicle 107. The vehicle based data processing system 110 can determine a frequency of use or interaction with one or more data structures stored in the user profile 140. Thus, the vehicle based data processing system 110 can generate confidence scores 145 based in part on a user of the vehicle 107 and a user profile 140 corresponding to the user of the vehicle 107. The vehicle based data processing system 110 can arrange the plurality of data structures 165 within the search interface 160 based on the confidence scores 145.

The vehicle based data processing system 110 can modify confidence scores 145 for data structures 165 responsive to an input or selection from a user of the vehicle 107. For example, the search interface 160 can provide a plurality of data structures 165 for display within the vehicle 107. The search interface 160 can obtain a second input corresponding to at least one data structure 165 of the plurality of data structures 165. The search interface 160 can provide the selected data structure 165 to the prediction module 130. The prediction module 130 can modify confidence scores 145 of each of the plurality of data structures 165 responsive to the second input. For example, the second input can correspond to an interaction with the user of the vehicle 107 to remove the data structure 165 from the search interface 160. The vehicle based data processing system 110 can generate instructions to remove the data structure 165 from the search interface 160 and add one new data structure 165 to the plurality of data structures 165 selected for display within the search interface 160. The prediction module 130 can generate new or updated confidence scores 145 for the new set or new plurality of data structures 165 selected for display within the search interface 160. The vehicle based data processing system can generate instructions to provide the new plurality of data structures 165 for concurrent display by the search interface 160 with the new plurality of data structures 165 arranged based on the modified confidence scores 145. The search interface 160 can execute the instructions from the vehicle based data processing system 110 to display the new plurality of data structures 165 for concurrent display by the search interface 160 with the new plurality of data structures 165 arranged based on the modified confidence scores 145.

The method 500 can include receiving user selections (ACT 540). For example, the method 500 can include receiving, by the search interface 160, a user selection of one of the first output corresponding to the first data structure 165 or the second output corresponding to the second data structure 165. The method 500 can include receiving, by the search interface 160, a user selection of one of the first output corresponding to the first data structure 165. The method 500 can include receiving, by the search interface 160, a user selection of one of the second output corresponding to the second data structure 165. The vehicle based data processing system 110, through the search interface 160, can receive at least one user selection corresponding to a selection of at least one output corresponding to at least one data structure 165. The vehicle based data processing system 110, through the search interface 160, can receive at least one user selection corresponding to a selection of at least one data structure 165. The user selection can be received through at least one display 155 of the search interface 160. For example, the user selection can be received through the display 155 providing the data structure 165 selected by the user of the vehicle 107. The user selection can be received through the display 155 providing the output corresponding to a data structure 165 selected by the user of the vehicle 107. The displays 155 of the search interface 160 can include or correspond to touch screens. The search interface 160, responsive to contact with at least one display 155, can generate a touch signal corresponding to the contact. The touch signal can identify the data structure 165 that was selected and the display 155 that the data structure 165 was provided in. The search interface 160 can transmit the touch signal to the vehicle based data processing system 110.

The vehicle based data processing system 110 can identify a touch signal corresponding to the interaction or user selection through the display 155 providing the data structure 165. For example, the touch signal can represent of a position or location of at least one display 155 of the display module 150 dedicated to the search interface 160. The touch signal can be responsive to contact with the location of the display 155 within the search interface 160. The location and display 155 can correspond to at least one data structure 165 provided within the respective display 155. For example, the displays 155 of the search interface 160 can receive an input through contact with a surface of at least one display 155. The vehicle based data processing system 110 can detect a horizontal and vertical orientation of the contact to determine which display 155 the user interacted with. The vehicle based data processing system 110 can identify the data structure 165 provided within the determine display 155 using the horizontal and vertical orientation data.

The vehicle based data processing system 110 can receive the user interaction through an interaction with an input device 180 of the information cluster 105. For example, the input device 180 can communicatively couple with the vehicle based data processing system 110, for example, through a wireless connection. The input device 180 can couple with the vehicle based data processing system 110, for example, through a wired connection. The input device 180 can include buttons or keypads to generate a signal responsive to contact. The signal can identify a display 155 and a data structure 165 provided within the respective display 155. The signal can correspond to a directional input or motion input to interact with data structures 165 provided within the displays 155 dedicated to the search interface 160. Thus, the input device 180 can generate a signal indicating the selection of at least one data structure 165 provided within the search interface 160.

The method 500 can include generating instructions (ACT 545). For example, the method 500 can include providing, by the vehicle based data processing system 110, instructions to invoke at least one action corresponding to at least one data structure 165 or selected output. The method 500 can include generating instructions to invoke a first action corresponding to a first data structure 165. The method 500 can include generating instructions to invoke a second action corresponding to a second data structure 165. The method 500 can include providing, by the vehicle based data processing system 110, instructions to invoke the first action corresponding to the first data structure 165. The vehicle based data processing system 110 can execute the first action for the vehicle 107 using at least one of the phone menu, the navigation menu, the entertainment menu, the climate control menu and the application 175. The method 500 can include providing, by the vehicle based data processing system 110, instructions to invoke the second action corresponding to the second data structure 165. The vehicle based data processing system 110 can execute the second action for the vehicle 107 using at least one of the phone menu, the navigation menu, the entertainment menu, the climate control menu and the application 175. The method 500 can include providing, by the vehicle based data processing system 110, instructions to invoke an application 175 corresponding to the selected data structure 165. The vehicle based data processing system 110 can generate instructions based on at least one selected data structure 165 to invoke an application 175. The application 175 can be linked with the selected data structure 165. For example, the output or data structure 165 selected can correspond to an auto dealership the user of the vehicle 107 uses to service or otherwise repair the vehicle 107. The data structure 165 can be linked with an application 175 (e.g., mobile application) hosted by a server 170 for the auto dealership. The vehicle based data processing system 110 can identify the application 175. The vehicle based data processing system 110 can generate instructions for the application 175 or for the server 170 hosting the application 175. The instructions can identify the respective application 175 and the server 170 hosting the application 175. The instructions can identify the server 170 hosting the application 175. The instructions can include a request for the application 175 or server 170 to retrieve data corresponding to the selected data structure 165. For example, in the auto dealership example, the vehicle based data processing system 110 can generate instructions to invoke or cause the application 175 or server 170 to generate data for the user of the vehicle 107. The data can include, a service schedule, types of repairs available, costs for different types of servers or repairs, and contact information for the auto dealership.

The vehicle based data processing system 110 can generate links to at least one application 175 for the data structures 165. The vehicle based data processing system 110 can embed the links (e.g., hyperlink) within the data structures 165 and corresponding instructions within the data structures 165 such that in response to a user selection of at least one data structure 165 the instructions for the application 175 can be generated. For example, the instructions can be generated or transmitted to an application 175 or server 170 responsive to a user selection of at least one data structure 165. The vehicle based data processing system 110 can generate the displays 155 of the search interface 160 having data structures 165 with hyperlinks such that when a user of the vehicle 107 interacts or selects at least one data structure 165, the vehicle based data processing system 110 connects with the respective application 175 or server 170.

The vehicle based data processing system 110 can provide instructions to invoke a system of the vehicle 107 corresponding to the selected data structure 165. The vehicle based data processing system 110 can generate instructions based on at least one selected output or selected data structure 165 to invoke a system (e.g., climate control menu, navigation menu, entertainment menu) or invoke an action using a system (e.g., climate control menu, navigation menu, entertainment menu). The system can be linked with the selected output or selected data structure 165. For example, the data structure 165 selected can correspond to navigation menu executing within the information cluster 105 of the vehicle 107. The vehicle based data processing system 110 can identify the application 175. The vehicle based data processing system 110 can generate instructions for the system. The instructions can identify the respective system and include an action such as a request for the system to retrieve data corresponding to the selected data structure 165. For example, in the navigation menu example, the vehicle based data processing system 110 can generate instructions to invoke or cause the system to generate data (e.g., action) corresponding to directions to a point of interest corresponding to the selected data structure 165.

The vehicle based data processing system 110 can generate links to at least one system for the data structures 165. The vehicle based data processing system 110 can embed the links (e.g., hyperlink) within the data structures 165 and corresponding instructions within the data structures 165 such that in response to a user selection of at least one data structure 165 the instructions for the system can be generated. For example, the instructions can be generated or transmitted to a system of the vehicle 107 responsive to a user selection of at least one data structure 165. The vehicle based data processing system 110 can generate the displays 155 of the search interface 160 having data structures 165 with hyperlinks such that when a user of the vehicle 107 interacts or selects at least one data structure 165, the vehicle based data processing system 110 connects or activates the respective system of the vehicle 107.

The method 500 can include transmitting the instructions (ACT 550). For example, the method 500 can include transmitting, by the vehicle based data processing system 110, the instructions to at least one application 175 or at least one server 170. The vehicle based data processing system 110 can transmit the instructions to a single application 175 or a single server 170. The vehicle based data processing system 110 can transmit the instructions to multiple applications 175 or multiple servers 170. For example, the vehicle based data processing system 110 can generate instructions corresponding to a selected data structure that represents coffee shops within a geographical range of a current position of the vehicle 107. The vehicle based data processing system 110 can identify multiple coffee shops within the geographical range (e.g., 1 mile, 5 miles) of the current position of the vehicle 107. The vehicle based data processing system 110 can identify applications 175 or servers 170 corresponding to the multiple coffee shops. The vehicle based data processing system 110 can generate instructions to retrieve data for each of the identified applications 175 or servers 170 corresponding to the multiple coffee shops. The vehicle based data processing system 110 can generate instructions to retrieve data for each of the identified applications 175 or servers 170 corresponding to the multiple coffee shops within the geographical range of the current position of the vehicle 107. Thus, the vehicle based data processing system 110 can request data from each of the applications 175 or servers 170 providing similar services or products to compare options or prices. The instructions can invoke or cause an application 175 or server 170 to generate requested data (e.g., perform an action) corresponding to the selected data structure 165. The vehicle based data processing system 110 can generate a set of instructions to be executed by the application 175 or server 170. Responsive to the instructions, the application 175 or the server 170 can generate or retrieve the requested data corresponding to selected data structure 165. For example, the selected data structure 165 can correspond to a sandwich shop. The vehicle based data processing system 110 can a set of instructions to cause a third party application 175 or third party server 170 corresponding to the sandwich shop data structure 165 to retrieve menu data and price data. The vehicle based data processing system 110 can a set of instructions to cause a third party application 175 or third party server 170 to generate data, such as, a listing of products offered, a listing of services offered, advertisements or offers provided, or other forms of data from a store or business corresponding to the selected data structure 165.

The vehicle based data processing system 110 can transmit the instructions to at least one system of the vehicle 107. The vehicle based data processing system 110 can transmit the instructions to a single system. The vehicle based data processing system 110 can transmit the instructions to multiple systems. The vehicle based data processing system 110 can generate instructions to retrieve data from the respective system corresponding to the selected data structure 165. For example, the selected data structure 165 can correspond to a climate control menu for the vehicle 107. The vehicle based data processing system 110 can generate instructions (e.g., perform an action) to retrieve temperature data (e.g., inside temperature, outside temperature, seat temperature) for the vehicle 107. The instructions can invoke or cause the system to generate requested data corresponding to the selected data structure 165. Responsive to the instructions, the system of the vehicle 107 can generate or retrieve the requested data corresponding to selected data structure 165. For example, the climate control menu can provide temperature data to the vehicle based data processing system 110 for display through the information cluster 105 to a user of the vehicle 107.

The method 500 can include receiving data corresponding to the selected data structure 165 (ACT 555). For example, the method 500 can include receiving responsive to the instructions, by the vehicle based data processing system 110, data from at least one application 175, at least one server 170, or at least one system of the vehicle 107. The vehicle based data processing system 110 can receive the data from a plurality of applications 175, a plurality of servers 170, or a plurality of systems of the vehicle 107. The vehicle based data processing system 110 can compare the received data to determine which data to provide to or display to a user of the vehicle 107. For example, the vehicle based data processing system 110 can compare the prices of similar goods or services to identify a best priced option to provide to or display to a user of the vehicle 107. The vehicle based data processing system 110 can compare the prices of similar goods or services to identify a listing of multiple best priced options to provide to or display to a user of the vehicle 107. The vehicle based data processing system 110 can receive data, such as advertisements, from a plurality of applications 175 or a plurality of servers 170. The vehicle based data processing system 110 can store the received data within the memory 125.

The vehicle based data processing system 110 can receive a second or subsequent input from a user of the vehicle 107 and modify or generate new data files 120 responsive to the second or sequent input. For example, the search interface can obtain a second input. The second input can be received through at least one display 155 of the search interface 160. The second input can be received through at least one display 155 of the information cluster 105. The second input can be received through an input device 180. The second input can correspond to a text entered through the search interface 160. The input can correspond to a selected icon presented within the search interface 160. Responsive to the second input or a subsequent input, the vehicle based data processing system 110 can generate instructions to execute the search module 135. For example, the search module 135 can, responsive to the second input, identify a first system or application 175 of the vehicle 107. The search module 135 can extract a plurality of data files 120 corresponding to the first system (e.g., entertainment menu, navigation menu) of the vehicle 107, for example, from the database 115. The search module 135 can extract a plurality of data files 120 from the first system of the vehicle 107, and stored in the database 115. The search module 135 can extract a plurality of data files 120 corresponding to or from the first application 175 (e.g., music application, coffee application) of the vehicle 107, for example, from the database 115 or from a server 170 hosting the first application 175. The search module 135 can provide the extracted data files 120 to the prediction module 130.

The prediction module 130 can assign confidence scores 145 to each of the plurality of data files 120 from the first system of the vehicle 107. The prediction module 130 can assign confidence scores 145 to each of the plurality of data files 120 from the first application 175 of the vehicle 107. For example, the prediction module 130 can assign confidence scores 145 for the different data files 120 based in part on a properties stored in a user profile 140 corresponding to a user of the vehicle 107. The prediction module 130 can assign confidence scores 145 for the different data files 120 based in part on a frequency of use or frequency of interaction with content corresponding to the respective data file 120. The prediction module 130 can provide the data files 120 having the confidence scores 145 to the vehicle based data processing system 110. The vehicle based data processing system 110 can provide the plurality of data files 120 for display by the search interface 160. The vehicle based data processing system 110 can arrange or order the plurality of data files 120 within the search interface 160 based on the confidence scores 145. For example, the vehicle based data processing system 110 can generate instructions to display a first data file 120 having a first confidence score 145 (e.g., highest confidence score 145) in a first display 155 of the search interface 160. The vehicle based data processing system 110 can generate instructions to display a second data file 120 having a second confidence score 145 (e.g., less than the first confidence score 145) in a second display 155 of the search interface 160.

The search interface 160 can obtain a second input and provide data corresponding to the second input to the vehicle based data processing system 110 or the search module 135. For example, responsive to the second input, the search module 135 can identify a first application 175 of the vehicle 107 and a second application 175 of the vehicle 107. Responsive to the second input, the search module 135 can identify a first system of the vehicle 107 and a second system of the vehicle 107. The search module 135 can provide the identified first and second applications 175 to the vehicle based data processing system 110. The search module 135 can provide the identified first and second systems to the vehicle based data processing system 110. The vehicle based data processing system 110 can generate a first instruction for the first application 175 and a second instruction for the second application 175. For example, the first and second instructions can identify a display 155 to provide the respective application 175, a position of the display 155 within the information cluster 105, and a link to execute or interact with the respective system. The vehicle based data processing system 110 can generate a first instruction for the first system of the vehicle 107 and a second instruction for the second system of the vehicle 107. For example, the first and second instructions can identify a display 155 to provide the respective system, a position of the display 155 within the information cluster 105 and a link to execute or interact with the respective system. The vehicle based data processing system 110 can provide the first application 175 and the second application 175 for concurrent display by the search interface 160. The vehicle based data processing system 110 can provide the first system of the vehicle 107 and the second system of the vehicle 107 for concurrent display by the search interface 160. The search interface 160 can receive a user selection of the first application 175 or the second application 175. The vehicle based data processing system 110 can execute the first instructions corresponding to the selected first application 175 or the second application 175. For example, the instructions can include a link to activate or open the respective application 175 within at least one display 155 of the information cluster 105. The application 175 can correspond to a music application 175 hosted by a server 170. The vehicle based data processing system 110 can execute the instructions to activate the music application 175 for interaction (e.g., to play music) through an entertainment system of the vehicle 107 responsive to an input from a user of the vehicle 107. The search interface 160 can receive a user selection of the first system or the second system. The vehicle based data processing system 110 can execute the first instructions corresponding to the selected first system or the second system of the vehicle 107. For example, the instructions can include a link to activate or open the respective system within at least one display 155 of the information cluster 105. The system can correspond to a climate control menu for the vehicle 107. The vehicle based data processing system 110 can execute the instructions to activate the climate control system for interaction (e.g., to change a temperature within the vehicle 107) through the climate control menu of the vehicle 107 responsive to an input from a user of the vehicle 107.

The vehicle based data processing system 110 can, responsive to a second input provide a plurality of data structures 165 for display by the search interface 160. The search interface 160 can execute instructions from the vehicle based data processing system 110 can display the plurality of data structures 165. The search interface 160 can obtain a third input or subsequent input. The vehicle based data processing system 110 can modify one or more data structures 165 of the plurality of data structures 165 responsive to the third input for display by the search interface 160. For example, the third input can correspond to an interaction with the user of the vehicle 107 to remove at least one data structure 165 from the search interface 160. The vehicle based data processing system 110 can generate instructions to remove a first data structure 165 of the plurality of data structures 165 from the search interface 160. The search interface 160 can execute the instructions from the vehicle based data processing system 110 and remove the first data structure 165 from at least one display 155. The vehicle based data processing system 110 can generate instructions to display a new data structure 165 not originally included within the plurality of data structures 165 for display within the search interface 160. The search interface 160 can execute the instructions from the vehicle based data processing system 110 and display the new data structure 165 within at least one display 155 of the plurality of displays 155 allocated to the search interface 160.

The vehicle based data processing system 110 can extract data or data files 120 from at least one application 175 or at least one third party server 170 responsive to an input or selection from a user of the vehicle 107. For example, the vehicle based data processing system 110 can obtain, from the search interface 160, a second input. The vehicle based data processing system 110 can extract third party data from a third party server 170 responsive to the second input. The second input can correspond to a text or phrase corresponding to a third party application 175 or third party server 170 and provided through at least one display 155 of the search interface 160. The second input can correspond to an interaction an icon corresponding to a third party application 175 or third party server 170 provided within at least one display 155 of the search interface 160. The vehicle based data processing system 110 can identify the application 175 or server 170 corresponding to the text, phrase or selected icon and establish a connection (e.g., wireless connection) to the identified the application 175 or server 170. The vehicle based data processing system 110 can transmit a request for data or extract data from the identified the application 175 or server 170. The vehicle based data processing system 110 can provide the third party data to the prediction module 130. The prediction module 130 can generate, using the extracted third party data, one or more data structures 165 (e.g., a first data structure and a second data structure 165). The vehicle based data processing system 110 can provide the data structures 165 generated using the third party data for concurrent display within displays 155 of the search interface 160. For example, the vehicle based data processing system 110 can provide the first data structure 165 having third party data and the second data structure 165 having third party data for concurrent display by the search interface 160.

The vehicle based data processing system can identify, responsive to a second input or subsequent input, a plurality of data files 120 from a plurality of systems of the vehicle 107, a plurality of applications 175 of the vehicle, or from a plurality of servers 170. For example, the search module 135 can identify, responsive to the second input, a plurality of third party data files 120 from a plurality of third party servers 170 and a plurality of data files 120 from systems of the vehicle 107. The search interface 160 can provide the third party data files 120 from the third party servers 170, the data files 120 from the applications 175 of the vehicle 107, and the data files from the systems of the vehicle 107 to the prediction module 130. The prediction module 130 can generate a first plurality of data structures 165 corresponding to the plurality of data files 120 (e.g., from the applications 175, from the systems of the vehicle 107) and a second plurality of data structures 165 corresponding to the plurality of third party data files 120 from the third party servers 170. The vehicle based data processing system can generate instructions to provide the first plurality of data structures 165 and the second plurality of data structures 165 for concurrent display by the search interface 160. For example, the search interface 160 can execute the instructions from the vehicle based data processing system 110 to provide the first plurality of data structures 165 and the second plurality of data structures 165 for concurrent display by the search interface 160.

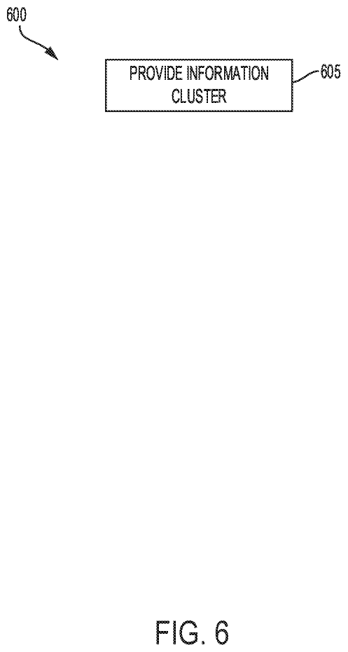

FIG. 6 depicts a method 600. The method 600 can include providing vehicle information cluster 105 of a vehicle 107 (ACT 605). The information cluster 105 can include a vehicle based data processing system 110 having a search module 135 and a prediction module 130. The information cluster 105 can include a search interface 160 communicatively coupled with the vehicle based data processing system 110. The search interface 160 can be provided within a first display 155 of a display module 150 of a vehicle 107. The search interface 160 can obtain a first input. The search module 135 can identify, responsive to the first input, a first data file 120 and a second data file 120. The prediction module 130 can generate, from the first data file 120, a first data structure 165. The prediction module 130 can generate, from the second data file 120, a second data structure 165. The vehicle based data processing system 110 can provide the first data structure 165 and the second data structure 165 for concurrent display by the search interface 160. The vehicle based data processing system 110 can receive a user selection of one of the first data structure 165 and the second data structure 165. The vehicle based data processing system 110 can provide instructions to invoke an application 175 corresponding to the selected data structure 165.

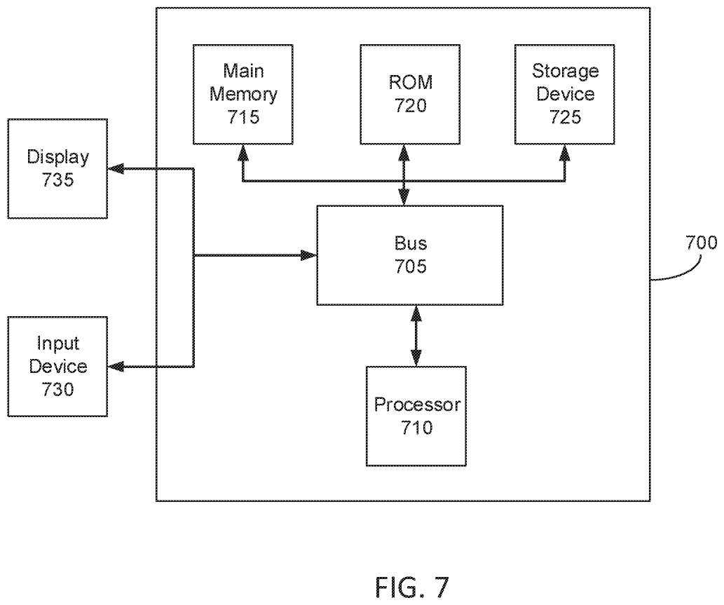

FIG. 7 is a block diagram of an example computer system 700. The computer system or computing device 700 can include or be used to implement the information cluster 105, or its components such as the vehicle based data processing system 110, display module 150, or search interface 160. The computing system 700 includes at least one bus 705 or other communication component for communicating information and at least one processor 710 or processing circuit coupled to the bus 705 for processing information. The computing system 700 can also include one or more processors 710 or processing circuits coupled to the bus for processing information. The computing system 700 also includes at least one main memory 715, such as a random access memory (RAM) or other dynamic storage device, coupled to the bus 705 for storing information, and instructions to be executed by the processor 710. The main memory 715 can be or include the memory 125. The main memory 715 can also be used for storing data files 120, data structures 165, user profiles 140, position information, vehicle information, command instructions, vehicle status information, environmental information within or external to the vehicle, road status or road condition information, or other information during execution of instructions by the processor 710. The computing system 700 may further include at least one read only memory (ROM) 720 or other static storage device coupled to the bus 705 for storing static information and instructions for the processor 710. A storage device 725, such as a solid state device, magnetic disk or optical disk, can be coupled to the bus 705 to persistently store information and instructions. The storage device 725 can include or be part of the memory 125.

The computing system 700 may be coupled via the bus 705 to a display 735, such as a liquid crystal display, or active matrix display, for displaying information to a user such as a driver of the vehicle 107. An input device 730, such as a keyboard or voice interface may be coupled to the bus 705 for communicating information and commands to the processor 710. The input device 730 can include a touch screen display 735. The input device 730 can also include a cursor control, such as a mouse, a trackball, or cursor direction keys, for communicating direction information and command selections to the processor 710 and for controlling cursor movement on the display 735. The display 735 (e.g., on a vehicle dashboard) can be part of the information cluster 105, the display module 150, displays 155, or the search interface 160, as well as part of the vehicle 107, for example.

The processes, systems and methods described herein can be implemented by the computing system 700 in response to the processor 710 executing an arrangement of instructions contained in main memory 715. Such instructions can be read into main memory 715 from another computer-readable medium, such as the storage device 725. Execution of the arrangement of instructions contained in main memory 715 causes the computing system 700 to perform the illustrative processes described herein. One or more processors in a multi-processing arrangement may also be employed to execute the instructions contained in main memory 715. Hard-wired circuitry can be used in place of or in combination with software instructions together with the systems and methods described herein. Systems and methods described herein are not limited to any specific combination of hardware circuitry and software.

Although an example computing system has been described in FIG. 7, the subject matter including the operations described in this specification can be implemented in other types of digital electronic circuitry, or in computer software, firmware, or hardware, including the structures disclosed in this specification and their structural equivalents, or in combinations of one or more of them.

Some of the description herein emphasizes the structural independence of the aspects of the system components (e.g., display module 150), and the information cluster 105. Other groupings that execute similar overall operations are understood to be within the scope of the present application. Modules can be implemented in hardware or as computer instructions on a non-transient computer readable storage medium, and modules can be distributed across various hardware or computer based components.

The systems described above can provide multiple ones of any or each of those components and these components can be provided on either a standalone system or on multiple instantiation in a distributed system. In addition, the systems and methods described above can be provided as one or more computer-readable programs or executable instructions embodied on or in one or more articles of manufacture. The article of manufacture can be cloud storage, a hard disk, a CD-ROM, a flash memory card, a PROM, a RAM, a ROM, or a magnetic tape. In general, the computer-readable programs can be implemented in any programming language, such as LISP, PERL, C, C++, C#, PROLOG, or in any byte code language such as JAVA. The software programs or executable instructions can be stored on or in one or more articles of manufacture as object code.

Example and non-limiting module implementation elements include sensors providing any value determined herein, sensors providing any value that is a precursor to a value determined herein, datalink or network hardware including communication chips, oscillating crystals, communication links, cables, twisted pair wiring, coaxial wiring, shielded wiring, transmitters, receivers, or transceivers, logic circuits, hard-wired logic circuits, reconfigurable logic circuits in a particular non-transient state configured according to the module specification, any actuator including at least an electrical, hydraulic, or pneumatic actuator, a solenoid, an op-amp, analog control elements (springs, filters, integrators, adders, dividers, gain elements), or digital control elements.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively, or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices include cloud storage). The operations described in this specification can be implemented as operations performed by a data processing apparatus on data stored on one or more computer-readable storage devices or received from other sources.

The terms “computing device”, “component” or “data processing apparatus” or the like encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data can include non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The subject matter described herein can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or a combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While acts or operations may be depicted in the drawings or described in a particular order, such operations are not required to be performed in the particular order shown or described, or in sequential order, and all depicted or described operations are not required to be performed. Actions described herein can be performed in different orders.

Having now described some illustrative implementations, it is apparent that the foregoing is illustrative and not limiting, having been presented by way of example. Features that are described herein in the context of separate implementations can also be implemented in combination in a single embodiment or implementation. Features that are described in the context of a single implementation can also be implemented in multiple implementations separately or in various sub-combinations. References to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any act or element may include implementations where the act or element is based at least in part on any act or element.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

The systems and methods described herein may be embodied in other specific forms without departing from the characteristics thereof. For example, the vehicle based data processing system can communicatively couple with more than one display module within a vehicle and generate multiple windows for each of the display modules. The foregoing implementations are illustrative rather than limiting of the described systems and methods. Scope of the systems and methods described herein is thus indicated by the appended claims, rather than the foregoing description, and changes that come within the meaning and range of equivalency of the claims are embraced therein.

Systems and methods described herein may be embodied in other specific forms without departing from the characteristics thereof. For example, descriptions of positive and negative electrical characteristics may be reversed. For example, elements described as negative elements can instead be configured as positive elements and elements described as positive elements can instead by configured as negative elements. Further relative parallel, perpendicular, vertical or other positioning or orientation descriptions include variations within +/−10% or +/−10 degrees of pure vertical, parallel or perpendicular positioning. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

What is claimed is:

1. A vehicle information system, comprising:
a vehicle based data processing system in a vehicle;
the vehicle based data processing system having a search module and a prediction module; and
a search interface communicatively coupled with the vehicle based data processing system, the search interface provided within a first display of a display module of a vehicle;
the search interface to:
obtain a first input from a user of the vehicle;
the search module to:
receive the first input from the search interface;
identify, responsive to the first input, a first data file and a second data file, the first data file and the second data file identified from at least one of a phone menu, a navigation menu, an entertainment menu, a climate control menu and an application;
the prediction module to:
generate, from the first data file, a first data structure, the first data structure corresponding to a first action to be executed using at least one of the phone menu, the navigation menu, the entertainment menu, the climate control menu and the application;
generate, from the second data file, a second data structure, the second data structure corresponding to a second action to be executed using at least one of the phone menu, the navigation menu, the entertainment menu, the climate control menu and the application;
the vehicle based data processing system to:
generate a first output corresponding to the first data structure and a second output corresponding to the second data structure;
provide the first output and the second output for concurrent display by the search interface;
the search interface to:
receive a user selection of the second output corresponding to the second data structure; and
the vehicle based data processing system to:
provide instructions to invoke the second action corresponding to the second data structure, the vehicle based data processing system to execute the second action for the vehicle using at least one of the phone menu, the navigation menu, the entertainment menu, the climate control menu and the application.

2. The system of claim 1, comprising:
the search interface to:
obtain a second input;
the search module to:
identify, responsive to the second input, a first application of the vehicle;
extract a plurality of data files from the application corresponding to the second input;
the prediction module to:
assign confidence scores to each of the plurality of data files from the first application; and
the vehicle based data processing system to:
provide the plurality of data files for display by the search interface, the plurality of data files ordered within the search interface based on the confidence scores.

3. The system of claim 1, comprising:
the vehicle based data processing system to:
determine a confidence score for the first data structure and the second data structure;
and
arrange the first data structure and the second data structure within the search interface based on the confidence score of the first data structure and the confidence score of the second data structure.

4. The system of claim 1, comprising:
the search interface to:
obtain a second input;
the search module to:
identify a first application of the vehicle and a second application of the vehicle responsive to the second input;
the vehicle based data processing system to:
generate a first instruction for the first application and a second instruction for the second application;
provide the first application and the second application for concurrent display by the search interface;
the search interface to:
receive a user selection of the first application; and
the vehicle based data processing system to:
execute the first instructions corresponding to the selected first application.

5. The system of claim 1, comprising:
the search interface to:
obtain a second input;
the vehicle based data processing system to:
provide a plurality of data structures responsive to the second input for display by the search interface;
the search interface to:
obtain a third input; and
the vehicle based data processing system to:
modify one or more data structures of the plurality of data structures responsive to the third input for display by the search interface.

6. The system of claim 1, comprising:
the vehicle based data processing system to:
generate a user profile for at least one passenger within the vehicle; and
generate a plurality of data files for the user profile of the at least one passenger within the vehicle, the user profile having at least one of: a location profile, a pattern profile, or a history profile of the user of the vehicle.

7. The system of claim 1, comprising:
the vehicle based data processing system to:
determine a user of the vehicle;
obtain, from the search interface, a second input from the user of the vehicle;
generate confidence scores for a plurality of data structures corresponding to the user of the vehicle; and
arrange the plurality of data structures within the search interface based on the confidence scores.

8. The system of claim 1, comprising:
the vehicle based data processing system to:
obtain, from the search interface, a second input;
the search module to:
identify a system of the vehicle corresponding to the second input;
the vehicle based data processing system to:
generate instructions for the system of the vehicle; and
execute the instructions corresponding to the system of the vehicle.

9. The system of claim 1, comprising:
the vehicle based data processing system to:
obtain, from the search interface, a second input;
extract third party data from a third party server responsive to the second input;
the prediction module to:
generate, using the extracted third party data, the first data structure and a second data structure; and
the vehicle based data processing system to:
provide the first data structure having third party data and the second data structure having third party data for concurrent display by the search interface.

10. The system of claim 1, comprising:
the vehicle based data processing system to:
obtain, from the search interface, a second input;
the search module to:
identify, responsive to the second input, a plurality of data files from a plurality of applications of the vehicle;
the search module to:
identify, responsive to the second input, a plurality of third party data files from a plurality of third party servers;
the prediction module to:
generate a first plurality of data structures corresponding to the plurality of data files and a second plurality of data structures corresponding to the plurality of third party data files; and
the vehicle based data processing system to:
provide the first plurality of data structures and the second plurality of data structures for concurrent display by the search interface.

11. The system of claim 1, comprising:
the search interface to:
provide a plurality of data structures for display within the vehicle;
obtain a second input corresponding to at least one data structure of the plurality of data structures;
the prediction module to:
modify confidence scores of each of the plurality of data structures responsive to the second input; and
the vehicle based data processing system to:
provide the plurality of data structures for concurrent display by the search interface, the plurality of data structures arranged based on the modified confidence scores.

12. The system of claim 1, comprising:
the display module having a plurality of displays visible within the vehicle; and
the first display of the plurality of displays visible within the vehicle when the vehicle is active, the first display providing the search interface.

13. The system of claim 1, comprising:
the search interface disposed within a dashboard of the vehicle.

14. The system of claim 1, comprising:
the search interface disposed within a console of the vehicle.

15. A method of providing data structures to a search interface for a vehicle information cluster, the method comprising:
providing, by a vehicle based data processing system in a vehicle, a search interface, the search interface provided within a first display of a display module of the vehicle, and the vehicle based data processing system having a search module and a prediction module;
obtaining, from the search interface, a first input from a user of the vehicle;
receiving, by the search module, the first input from the search interface;
identifying, by the search module and responsive to the first input, a first data file and a second data file, the first data file and the second data file identified from at least one of a phone menu, a navigation menu, an entertainment menu, a climate control menu and an application;
generating, by the prediction module and from the first data file, a first data structure, the first data structure corresponding to a first action to be executed using at least one of the phone menu, the navigation menu, the entertainment menu, the climate control menu and the application;
generating, by the prediction module and from the second data file, a second data structure; the second data structure corresponding to a second action to be executed using at least one of the phone menu, the navigation menu, the entertainment menu, the climate control menu and the application;
generating, by the vehicle based data processing system, a first output corresponding to the first data structure and a second output corresponding to the second data structure;
providing, by the vehicle based data processing system, the first output and the second output for concurrent display by the search interface;
receiving, by the search interface, a user selection of the second output corresponding to the second data structure; and
providing, by the vehicle based data processing system, instructions to invoke the second action corresponding to the second data structure, the vehicle based data processing system to execute the second action for the vehicle using at least one of the phone menu, the navigation menu, the entertainment menu, the climate control menu and the application.

16. The method of claim 15, comprising:
obtain, from the search interface, a second input;
identifying, by the search module and responsive to the second input, a first application of the vehicle;
extracting, by the search module, a plurality of data files from the application corresponding to the second input;
assigning, by the prediction module, confidence scores to each of the plurality of data files from the first application; and
providing, by the vehicle based data processing system, the plurality of data files for display by the search interface, the plurality of data files ordered within the search interface based on the confidence scores.

17. The method of claim 15, comprising:
obtaining, from the search interface, a second input;
identifying, by the search module, a first application of the vehicle and a second application of the vehicle responsive to the second input;
generating, by the vehicle based data processing system, a first instruction for the first application and a second instruction for the second application;
providing, by the vehicle based data processing system, the first application and the second application for concurrent display by the search interface;
receiving, by the search interface, a user selection of the first application; and
executing, by the vehicle based data processing system, the first instructions corresponding to the selected first application.

18. The method of claim 15 comprising:
obtaining, from the search interface, a second input;
providing, by the vehicle based data processing system, a plurality of data structures responsive to the second input for display by the search interface;
obtaining, from the search interface, a third input; and
modifying, by the vehicle based data processing system, one or more data structures of the plurality of data structures responsive to the third input for display by the search interface.

19. The method of claim 15, comprising:
obtaining, from the search interface, a second input;
identifying, by the search module and responsive to the second input, a plurality of data files from a plurality of applications of the vehicle;
identifying, by the search module and responsive to the second input, a plurality of third party data files from a plurality of third party servers;
generating, by the prediction module, a first plurality of data structures corresponding to the plurality of data files and a second plurality of data structures corresponding to the plurality of third party data files; and
providing, by the vehicle based data processing system, the first plurality of data structures and the second plurality of data structures for concurrent display by the search interface.

20. A vehicle, comprising:
a vehicle information system, the system comprising:
a vehicle based data processing system having a search module and a prediction module; and
a search interface communicatively coupled with the vehicle based data processing system, the search interface provided within a first display of a display module of a vehicle;
the search interface to:
obtain a first input from a user of the vehicle;
the search module to:
receive the first input from the search interface;
identify, responsive to the first input, a first data file and a second data file, the first data file and the second data file identified from at least one of a phone menu, a navigation menu, an entertainment menu, a climate control menu and an application;
the prediction module to:
generate, from the first data file, a first data structure, the first data structure corresponding to a first action to be executed using at least one of the phone menu, the navigation menu, the entertainment menu, the climate control menu and the application;
generate, from the second data file, a second data structure; the second data structure corresponding to a second action to be executed using at least one of the phone menu, the navigation menu, the entertainment menu, the climate control menu and the application;
the vehicle based data processing system to:
generate a first output corresponding to the first data structure and a second output corresponding to the second data structure;
provide the first output and the second output for concurrent display by the search interface;
the search interface to:
receive a user selection of the second output corresponding to the second data structure; and
the vehicle based data processing system to:
provide instructions to invoke the second action corresponding to the second data structure, the vehicle based data processing system to execute the second action for the vehicle using at least one of the phone menu, the navigation menu, the entertainment menu, the climate control menu and the application.
